(19) United States
(12) Patent Application Publication
(10) Pub. No.: US 2012/0027045 A1
(43) Pub. Date: Feb. 2, 2012

(54) PASSIVE THERMAL MONITORING SYSTEMS AND METHODS OF MAKING AND USING THE SAME

(75) Inventors: Joseph M. MCLELLAN, Quincy, MA (US); Brian T. Mayers, Arlington, MA (US); Adam Winkleman, Brookline, MA (US); Michael J. Fuerstman, Arlington, MA (US); George M. Whitesides, Newton, MA (US)

(73) Assignee: Nano Terra Inc., Brighton, MA (US)

(21) Appl. No.: 13/018,450

(22) Filed: Feb. 1, 2011

Related U.S. Application Data
(60) Provisional application No. 61/300,120, filed on Feb. 1, 2010.

(51) Int. Cl. G01K 11/06; G01K 7/34; G01K 11/00; G01K 7/36

(52) U.S. Cl. 374/160; 374/163; 374/184; 374/161; 374/E07.039; 374/E07.037; 374/E11.001; 374/E11.006

(57) ABSTRACT

The present invention is directed to passive thermal monitoring devices, and methods of making and using the passive thermal monitoring devices.

### CROSS-REFERENCE TO RELATED APPLICATIONS

This application claims the benefit of the filing date of U.S. Provisional Appl. No. 61/300,120, filed Feb. 1, 2010, which is incorporated herein by reference in its entirety.

### STATEMENT OF GOVERNMENT RIGHTS

The present invention was made with U.S. Government support under Contract Number W15QKN-09-C-0037 awarded by the United States Army. The U.S. Government has certain rights in the invention.

### BACKGROUND OF THE INVENTION

1. Field of the Invention

The present invention is directed to structures containing a thermally active material, methods for fabricating the structures, and methods of using the structures for passive thermal monitoring applications.

2. Background

Many materials that must be shipped and/or stored require environmental control during shipping and/or storage. While high costs associated with thermal monitoring can be acceptable for high-value materials such as tissue(s) for transplant purposes, blood, and the like, refrigerated storage is expensive and can add significantly to the cost of many lower-value, but nonetheless perishable consumer goods and other materials. For example, many pharmaceutical products, foodstuffs, ordinance, and the like can undergo spoilage, increased defective rates, and generate potentially toxic side products if these and other items are exposed to temperatures above a specific thermal load. A thermal load of an item accounts for both the maximum temperatures that an item is exposed to during shipment and/or storage as well as the time at which the item endures the various temperatures. Thus, while an item may not be exposed to a temperature that is excessively high, long-term exposure to a lower thermal environment can be nonetheless deleterious to one or more performance metrics of a product.

While there are many thermal monitoring devices that are suitable for passively monitoring the maximum temperature to which an item is exposed, only more expensive thermal monitoring devices having integrated solid state electronics and data memory are currently sufficient for monitoring the temperature history of an item over long terra storage and/or shipment. The additional cost associated with the use such thermal monitoring devices is often not justified, or adds considerably to the overall cost of shipment and storage of many consumer products and other items.

### BRIEF SUMMARY OF THE INVENTION

There is a need for low-cost, easy-to-use and easy-to-make passive thermal monitoring devices capable of both recording the maximum temperature to which an item is exposed, as well as recording the duration for which a product is exposed to a certain temperature. Further embodiments, features, and advantages of the present inventions, as well as the structure and operation of the various embodiments of the present invention, are described in detail below with reference to the accompanying drawings.

The present invention is directed to a passive thermal monitoring system comprising a matrix including at least a first channel therein, wherein the first channel has a cross-sectional area; and at least a first thermally active material having a melting point within:

a first range of −20° C. to 50° C., or

a second range of 51° C. to 100° C., or

a third range of 101° C. to 150° C., or

a fourth range of 151° C. to 200° C., or

a fifth range of 201° C. to 250° C.;

wherein the first thermally active material is positioned to be in fluid communication with at least the first channel in a fluid state, and wherein a flow of the first thermally active material in a fluid state into and through at least the first channel occurs only above a threshold temperature characteristic of an interaction between the first thermally active material and the first channel.

In some embodiments, the first channel comprises a first functional group.

In some embodiments, the first thermally active material is a substantially pure, optionally substituted hydrophobic alkane, and the first functional group is a hydrophobic functional group.

In some embodiments, the passive thermal monitoring system comprises a second thermally active material having a melting point within one of the first range through fifth ranges, wherein the melting points of the first and the second thermally active materials are in different ranges, wherein the second thermally active material is positioned to be in fluid communication with at least a second channel in a fluid state, and wherein a flow of the second thermally active material in a fluid state into and through at least the second channel occurs only above a threshold temperature characteristic of an interaction between the second thermally active material and the second channel.

In some embodiments, the second channel comprises a second functional group.

In some embodiments, the second thermally active material is a substantially pure, optionally substituted hydrophilic alkane, and the second functional group is a hydrophobic functional group.

In some embodiments, the first and second channels are in at least partial fluid communication.

In some embodiments, the passive thermal monitoring system comprises a third thermally active material having a melting point within one of the first through fifth ranges, wherein the melting points of the first, second, and third thermally active materials are in different ranges, wherein the third thermally active material is positioned to be in fluid communication with at least a third channel in a fluid state, and wherein a flow of the third thermally active material in a fluid state into and through at least the third channel occurs only above a threshold temperature characteristic of an interaction between the third thermally active material and the third channel.

In some embodiments, the third channel comprises a third functional group.

In some embodiments, the third thermally active material is a eutectic metal and the third functional group is a hydrophilic functional group.

In some embodiments, the first, second and third channels are in at least partial fluid communication.

In some embodiments, thee passive thermal monitoring system comprises a fourth thermally active material having a melting point within one of the first through fifth ranges, wherein the melting points of the first, second, third, and fourth thermally active materials are in different ranges, wherein the fourth thermally active material is positioned to be in fluid communication with at least a fourth channel in a fluid state, and wherein a flow of the fourth thermally active material in a fluid state into and through at least the fourth channel occurs only above a threshold temperature characteristic of an interaction between the fourth thermally active material and the fourth channel.

In some embodiments, the fourth channel comprises a fourth functional group.

In some embodiments, the fourth thermally active material is a eutectic metal, and the fourth functional group is a hydrophilic functional group.

In some embodiments, the first, second, third and fourth channels are in at least partial fluid communication.

The present invention is also directed to a passive thermal monitoring system comprising a matrix that includes a plurality of channels therein, wherein each channel has an independent cross-sectional area of 10 mm² or less; and a thermally active material that is positioned to be in fluid communication with the plurality of channels in a fluid state; wherein a flow of the thermally active material in a fluid state into one or more of the channels is temperature dependent and occurs above a threshold temperature characteristic of an individual channel, wherein the thermally active material in a fluid state progresses through one or more of the channels above the threshold temperature characteristic of an individual channel, and wherein the threshold temperature at which the thermally active material flows into and then progresses through each of the individual channels is different.

In some embodiments, the thermally active material in one or more of the plurality of channels is stationary below the threshold temperature characteristic of each of the channels.

In some embodiments, the thermally active material has a melting point of −20° C. to 250° C.

In some embodiments, the thermally active material is selected from a liquid, a solid, a semi-solid, a colloid, a gel, a wax, a fat, an oil, a metal, an ionic liquid, an oligomer, a polymer, a co polymer, and combinations thereof.

In some embodiments, one or more of the channels is in fluid communication with a reservoir at a first end of the channel and is in partial fluid communication with a reservoir at a second end of the channel.

In some embodiments, one or more of the channels is fluidly isolated from the other channels.

In some embodiments, at least one of the plurality of channels comprises a functional group.

In some embodiments, the flow into and the rate of flow of the thermally active material through one or more of the plurality of channels is dependent on at least a functional group within or on at least a portion of the channel.

In some embodiments, the functional group interacts with a component of the thermally active material to induce at least one of: a color change, a change in refractive index, a change in reflectance, or a combination thereof within at least one of the plurality of channels.

In some embodiments, the flow into and the rate of flow of the thermally active material through one or more of the channels is dependent on at least the independent cross-sectional area of the channel.

In some embodiments, the monitoring system is suitable for recording the temperature history of an object from 30° C. to 250° C.

The present invention is also directed to a passive thermal monitoring system comprising a matrix including at least a first, a second, a third and a fourth channel therein, wherein the first, second, third and fourth channels have a cross-sectional area that is the same or different;

a first thermally active material having a melting point of −20° C. to 60° C., wherein the first thermally active material is positioned to be in fluid communication with at least the first channel in a fluid state, and wherein a rate of flow of the first thermally active material in a fluid state into and through at least the first channel occurs only above a threshold temperature that is 20° C. to 60° C.;

a second thermally active material having a melting point of 61° C. to 120° C., wherein the second thermally active material is positioned to be in fluid communication with at least the second channel in a fluid state, and wherein a rate of flow of the second thermally active material in a fluid state into and through at least the second channel occurs only above a threshold temperature that is 61° C. to 120° C.;

a third thermally active material having a melting point of 121° C. to 180° C., wherein the third thermally active material is positioned to be in fluid communication with at least the third channel in a fluid state, and wherein a rate of flow of the third thermally active material in a fluid state into and through at least the third channel occurs only above a threshold temperature that is 121° C. to 180° C.; and

a fourth thermally active material having a melting point of 181° C. to 250° C., wherein the fourth thermally active material is positioned to be in fluid communication with at least the fourth channel in a fluid state, and wherein a rate of flow of the fourth thermally active material in a fluid state into and through at least the fourth channel occurs only above a threshold temperature that is 181° C. to 250° C.

In some embodiments, the first channel comprises a first functional group, the second channel comprises a second functional group, the third channel comprises a third functional group, and the fourth channel comprises a fourth functional group; and wherein the first, second, third and fourth functional groups are independently the same or different.

In some embodiments, the rate of flow of the first thermally active material in a fluid state into and through at least the first channel is dependent on at least an interaction between the first thermally active material and the first functional group; wherein the rate of flow of the second thermally active material in a fluid state into and through at least the second channel is dependent on at least an interaction between the second thermally active material and the second functional group; wherein the rate of flow of the third thermally active material in a fluid state into and through at least the third channel is dependent on at least an interaction between the third thermally active material and the third functional group; wherein the rate of flow of the fourth thermally active material in a fluid state into and through at least the fourth channel is dependent on at least an interaction between the fourth thermally active material and the fourth functional group.

The present invention is also directed to a passive thermal monitoring system comprising a matrix that includes a channel therein having an opening and a terminus, wherein the channel comprises a plurality of fluidly connected segments, each segment having a cross-sectional area of 10 mm² or less; and a thermally active material having a melting point of 20° C. to 250° C., wherein the thermally active material is positioned to be in fluid communication with the beginning of the channel in a fluid state, wherein a flow of the thermally active material in a fluid state into the channel is temperature dependent and occurs only above a threshold temperature characteristic of an interaction between the thermally active material and the beginning of the channel, wherein a rate of flow of the thermally active material in a fluid state into each segment of the channel is temperature dependent above a threshold temperature characteristic of each segment of the channel and occurs only above a threshold temperature characteristic each segment of the channel, wherein a rate of flow of the thermally active material in a fluid state through one or more segments of the channel is temperature independent above the threshold temperature characteristic of the segment of the channel, and wherein the characteristic temperature of each segment of the channel is different and increases as the distance of each segment from the opening of the channel increases.

In some embodiments, the position of thermally active material in one or more segments of the channel is stationary below a threshold temperature characteristic of the segment of the channel.

In some embodiments, the thermally active material is selected from: water, a wax, a fat, an oil, an ionic liquid, a copolymer, a polymer, a solder, and combinations thereof.

In some embodiments, a colorant is mixed with the thermally active material.

In some embodiments, at least a portion of a surface of at least one of the one or more segments comprises one or more functional groups thereon that are the same or different between the plurality of segments.

In some embodiments, the characteristic temperature of one or more of the segment of the channel depends at least on an interaction between the thermally active material and one or more functional groups within or on one or more segments of the channel.

In some embodiments, the characteristic temperature of one or more segments of the channel depends at least on the independent cross-sectional area of the segments of the channel.

In some embodiments, one or more of the segments comprises a plurality of capillary channels extending from a surface of the segment, wherein a rate of flow of the thermally active material into and through each capillary channel of a segment of the channel is different and depends on at least one of: an ambient temperature, a functional group present on at least a portion of a surface of the capillary channel, and a cross-sectional area of the capillary channel.

In some embodiments, the matrix is transparent or opaque to visible light. In some embodiments, the matrix is flexible. In some embodiments, the matrix comprises a self adhesive backing layer.

The present invention is also directed to a passive thermal monitoring system comprising a magnetic material having a Curie temperature, the magnetic material having a known magnetic moment at a baseline temperature that is less than the Curie temperature, wherein exposure of the passive thermal monitoring system to a temperature greater than the baseline temperature provides an incremental decrease in the magnetic moment of the magnetic material such that the decrease in the magnetic moment after a period of use correlates with a maximum temperature to which the passive thermal monitoring system is exposed during the period of use.

In some embodiments, the magnetic material has a Curie temperature of −100° C. to 1200° C.

The present invention is also directed to a passive thermal monitoring system comprising first and second mechanical elements, a first magnetic material affixed on or in the first mechanical element; and a second magnetic material on or in a second mechanical element, wherein the first and second magnetic materials are attracted to one another by a magnetic force at a baseline temperature less than the Curie temperature of either magnetic material, wherein the first and second mechanical elements are configured to store potential energy in opposition to the attractive magnetic force between the first and second materials, wherein at a baseline temperature less than the Curie temperature of either magnetic material the stored potential energy is less than the magnetic attractive force between the first and second magnetic materials, and wherein at a temperature above the baseline temperature the attractive force between the first and second magnetic materials decreases such that the attractive force is less than the potential energy, and the potential energy is released as a mechanical reconfiguration of at least one of the first or second mechanical elements.

In some embodiments, the first and second mechanical elements are selected from: a substrate, a cantilever, a micromirror, a hinge, a deflector, a microfluidic valve, and combinations thereof.

The present invention is also directed to a passive thermal monitoring system comprising parallel conductive surfaces having a variable distance and a thermally sensitive material there between, wherein the thermally sensitive material has a coefficient of thermal expansion at 20° C. of at least 10 ppm/° C., and wherein linear change of the thermally sensitive material results in a change in capacitance between the parallel conductive surfaces.

The present invention is also directed to a passive thermal monitoring system comprising a reflective element and a thermally sensitive material having a coefficient of linear thermal expansion at 20° C. of at least 10 ppm/° C., wherein linear change of the thermally sensitive material modifies at least one of: the intensity of light or the angle of light reflected from the reflective element.

In some embodiments, the passive thermal monitoring system comprises a light source, wherein the reflective element is a minor, and linear expansion of the material modifies at least the angle of light reflected from the reflective element.

In some embodiments, the thermally sensitive material is an elastomer.

The present invention is also directed to a passive thermal monitoring system comprising at least a first thermally sensitive material in a solid state, wherein exposure of at least the first thermally sensitive material to a temperature greater than at least one of: a phase transition temperature of the first thermally sensitive material, a melting point of the first thermally sensitive material, or a softening temperature of the first thermally sensitive material provides an observable change in the passive thermal monitoring system.

In some embodiments, the passive thermal monitoring system comprises two conductive surfaces separated by at least the first they sensitive material in a solid state, wherein exposure of the first thermally sensitive material to a temperature greater than at least one of: a phase transition temperature of the first thermally sensitive material, a melting point of the first thermally sensitive material, or a softening temperature of the first thermally sensitive material provides a change in the conductivity between the two conductive surfaces.

In some embodiments, the passive thermal monitoring system comprises a second thermally sensitive material in a solid state, wherein exposure of the first and second thermally sensitive materials to a temperature greater than the melting points of the first and second thermally sensitive materials provides a mixing of the first and second thermally sensitive materials.

In some embodiments, at least one of the first and second thermally sensitive materials comprises a colorant, wherein mixing of the first and second thermally sensitive materials results in a color change, and wherein the color change correlates with a maximum temperature to which the passive thermal monitoring is exposed.

In some embodiments, exposure of at least the first thermally sensitive material to a temperature greater than at least one of: a phase transition temperature of the first thermally sensitive material, a melting point of the first thermally sensitive material, or a softening temperature of the first thermally sensitive material provides a relaxation of the of the passive thermal monitoring system into a relaxed state that is observable by a process selected from: a change in physical shape, a color change, an electrical capacitance change, an electrical conductivity change, a signal frequency change, and combinations thereof.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIG. 1 provides a cross-sectional schematic representation of channels in a matrix according to an embodiment of the present invention.

FIG. 2 provides a three-dimensional schematic representation of a passive thermal monitoring system of the present invention.

FIGS. 3A and 3B provide top-view schematic representations of a passive thermal monitoring system of the present invention.

FIG. 4 provides a three-dimensional schematic representation of a passive thermal monitoring system of the present invention.

FIGS. 5-10 provide top-view schematic representations of passive thermal monitoring systems of the present invention.

FIG. 11 provides a three-dimensional schematic representation of a passive thermal monitoring system of the present invention.

FIGS. 12A-12F provide a cross-sectional schematic representation of a passive thermal monitoring system of the present invention, and its operation.

One or more embodiments of the present invention will now be described with reference to the accompanying drawings, which are schematic and which are not intended to be drawn to scale. In the drawings, like reference numbers can indicate identical or functionally similar elements. Additionally, the left-most digit(s) of a reference number can identify the drawing in which the reference number first appears. For purposes of clarity, not every component is labeled in every figure, nor is every component of each embodiment of the invention shown where illustration is not necessary to allow those of ordinary skill in the art to understand the invention.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “some embodiments,” “one embodiment,” “an embodiment,” “an example embodiment,” etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

References to spatial descriptions (e.g., “above,” “below,” “up,” “down,” “top,” “bottom,” etc.) made herein are for purposes of description and illustration only, and should be interpreted as non-limiting upon the systems, devices, sensors, substrates, methods, and products of any method of the present invention, which can be spatially arranged in any orientation or manner.

As used herein, a “temperature event” refers to the ambient temperatures to which a system, or an item on which a system of the present invention is affixed, is exposed. A temperature event can refer to both a temperature to which a system is exposed as well as an interval of time the system is exposed to a temperature (i.e., both the temperature and the time of exposure).

The passive thermal monitoring systems of the present invention can be any shape or geometry. For example, the systems can have a rectilinear, cylindrical, curved, hemispherical and/or pyramidal shape, and the like, or any other three-dimensional shape known to persons of ordinary skill in the art. In some embodiments, a passive thermal monitoring system includes at least one flat surface suitable for affixing to an object.

The systems of the present invention can be fabricated using flexible and/or elastomeric materials that are capable of being flexed, twisted, bent, or otherwise distorted from a planar configuration. In some embodiments, a system of the present invention is suitable for conformal application to a non-planar (e.g., curved and/or tiered) surface of an object.

The passive thermal monitoring systems of the present invention can be used in terrestrial environments (e.g., on land, in the air, at sea, or in underwater environments) as well as in outer space.

As used herein, a “channel” refers to a semi-continuous or continuous two- or three-dimensional shape on, in, or through at least a portion of which a thermally active material can flow. In some embodiments, a channel comprises a three-dimensional region having a cross-sectional shape such as, but not limited to, a triangle, a rectilinear shape (e.g., a square, rectangle, and the like), a circle, an ellipse, a pentagon, a hexagon, an octagon, and combinations thereof.

In some embodiments, a channel is a “microfluidic channel,” which can refer to a channel having an internal volume less than 1 mL and/or a channel having a cross-sectional dimension (i.e., a diameter, width, and the like) less than 1 mm.

In some embodiments, at least one end of a channel is in fluid communication with a reservoir comprising a thermally active material. In some embodiments, a channel includes at least two openings that are optionally in fluid communication with a reservoir comprising a thermally active material. In some embodiments, a valve or removable barrier separates a channel from a reservoir.

The systems of the present invention can optionally contain a reservoir. As used herein, a “reservoir” refers to a portion of a matrix on and/or in which a thermally active material can be applied or contained prior to and/or after the system is exposed to a temperature event. In some embodiments, at least a portion of a reservoir is in fluid communication with a channel.

As used herein, a “matrix” refers to a material that at least partially defines a channel and a reservoir. A channel can be “disposed on,” “disposed within,” “disposed in,” “contained within,” “contained on,” or “contained in” a matrix. A channel can have substantially any three-dimensional orientation on and/or in a matrix. For example, a channel can be defined within a matrix, a channel can be positioned on a matrix, or a portion of the matrix can perform as the channel (e.g., in some embodiments, a matrix can function as a wicking material).

As used herein, “flow path” and/or “fluid path” are used interchangeably and refer to a portion of a channel in, on, or through which a thermally active material is contained, can flow, and optionally become solidified.

As used herein, “interconnected channels” refers to two or more channels on and/or in a matrix that are or are capable of communicating fluidically with one another. As used herein, “fluid communication” refers to the ability of a gas, liquid, semi-solid, gel, and the like to flow between channels. As used herein, “partial fluid communication” refers to the ability of a gas but not a liquid, semi-solid, gel, and the like to flow between channels.

As used herein, an “isolated” channel refers to a channel that comprises one or more fluid flow paths, wherein the flow paths of different channels do not intersect and are physically isolated from one other within a matrix. As such, a thermally active material present in a first isolated flow path of a channel cannot flow to a second fluid flow path of a second channel (i.e., is not in fluid communication with a second fluid flow path).

As used herein, a “longitudinal axis” of a channel or flow path within a channel refers to an axis disposed along the length of such channel or flow path, which is coextensive with and defined by the geometric centerline of the direction that a thermally active material can flow from a reservoir. For example, a “linear” or “straight” channel, or a segment thereof, includes a longitudinal axis that is essentially linear, while a channel comprising a series of such straight segments that are fluidically interconnected can have a longitudinal axis, comprising the interconnected longitudinal axes of the individual interconnected channels forming the fluid flow path, which is “non-linear.”

As used herein, a “non-linear” channel and/or flow path refers to a flow path or channel having a longitudinal axis that deviates from a straight line along its length by more than an amount equal to the minimum cross-sectional dimension of the channel or flow path. Non-linear channels include, but are not limited to, a racetrack channel (e.g., a channel that is substantially connected with itself, the entirety of which is in substantial gaseous communication, but which can optionally contain a fluid terminus that prevents a thermally active material from flowing upon itself), a serpentine channel (e.g., channel having one or more turns, elbows, corners, vias, and combinations thereof, and which does not substantially connect with itself at any point), and combinations thereof (e.g., a channel comprising multiple segments that are optionally in a linear, racetrack, or serpentine configuration).

As used herein, a “tapered” channel and/or flow path refers to such flow path and/or channel having a varied cross-sectional dimension such that a width, height, and/or cross-sectional dimension of at least two different locations within the channel and/or flow path is different. A channel can be “negatively tapered” (i.e., a configuration in which a width, height and/or cross-sectional dimension of a channel or flow path decreases as a distance from an end of a channel that is fluidically connected to a thermally sensitive material source increases), “positively tapered” (i.e., a configuration in which a width, height and/or cross-sectional area of a channel or flow path increases as a distance from an end of a channel that is fluidically connected to a thermally sensitive material source increases), or a combination thereof.

As used herein, a “cross-sectional dimension” refers to the smallest cross-sectional dimension for a cross-section of a channel as measured substantially perpendicular to a long or longitudinal axis of a channel. Cross-sectional dimensions are describes in units of size (i.e., nm, μm, mm, and the like) and can include, but are not limited to, width, height, radius, diameter, and the like.

In some embodiments, each channel within a system of the present invention has at least one cross-sectional dimension of 2 mm or less, 1 mm or less, 500 μm or less, 250 μm or less, 100 μm or less, 50 μm or less, 20 μm or less, 15 μm or less, 10 μm or less, 5 μm or less, 2 μM or less, 1 μm or less, 800 nm or less, 700 nm or less, 650 nm or less, or 500 nm or less. In some embodiments, each channel within a system of the present invention has at least one cross-sectional dimension of 500 nm to 2 mm, 750 nm to 2 mm, 1 μm to 2 mm, 5 μm to 1.75 mm, 10 μm to 1.5 mm, 20 μm to 1.25 mm, 50 μm to 1 mm, 100 μm to 750 μm, 50 μm to 500 μm, 250 μm to 2 mm, or 500 μm to 2 mm.

As used herein, a “cross-sectional area” refers to the area of a channel or a flow path there through as measured substantially perpendicular to a long or longitudinal axis of a channel or flow path. In some embodiments, a cross-sectional area of a channel is substantially the same as a cross-sectional area of a flow path there through. In some embodiments, a cross-sectional area of a channel is greater than a cross-sectional area of a flow path there through. A difference between the cross-sectional area of a channel and a flow path can be due to the presence of, e.g., a filler material, a liner, and the like, and combinations thereof, within a channel.

In some embodiments, a system of the present invention includes channels that are approximately the same cross-sectional dimension. In some embodiments, a system of the present invention includes channels having depths and areas that are: substantially the same (i.e., a channel has a substantially square cross-sectional area) and/or substantially different. In some embodiments, a channel includes curved or beveled corners and/or edges.

In some embodiments, each channel within a system of the present invention has a cross-sectional area of 10 mm² or less, 5 mm² or less, 2.5 mm² or less, 2 mm² or less, 1.5 mm² or less, 1 mm² or less, 0.5 mm² or less, 0.2 mm² or less, 0.1 mm² or less, 0.05 mm² or less, 0.01 mm² or less, 5,000 μm² or less, 1,000 μm² or less, 500 μm² or less, 100 μm² or less, 50 μm² or less, 40 μm² or less, 30 μm² or less, 10 μm² or less, or 5 μm² or less.

In some embodiments, a channel within a system of the present invention has a cross-sectional area of 1 μm² to 10 mm², 2 μm² to 10 mm², 5 μm² to 10 mm², 10 μm² to 10 mm², 20 μm² to 10 mm², 30 μm² to 10 mm², 40 μm² to 10 mm², 50 μm² to 10 mm², 1 μm² to 5 mm², 5 μm² to 5 mm², 10 μm² to 5 mm², 50 μm² to 5 mm², 1 μm² to 1 mm², 5 μm² to 1 mm², 10 μm² to 1 mm², 20 μm² to 1 mm², 30 μm² to 1 mm², 40 μm² to 1 mm², 50 μm² to 1 mm², 1 μm² to 0.01 mm², 2 μm² to 0.01 mm², 5 μm² to 0.01 mm², 10 μm² to 0.01 mm², 20 μm² to 0.01 mm², 30 μm² to 0.01 mm², 40 μm² to 0.01 mm², 50 μm² to 0.01 mm², 100 μm² to 10 mm², 200 μm² to 10 mm², 250 μm² to 10 mm², 500 μm² to 10 mm², or 1,000 μm² to 10 mm².

The passive thermal monitoring systems of the present invention are not particularly limited by size, shape, or geometry. For example, the passive thermal monitoring systems of the present invention are suitable for placement in virtually any location, in virtually any environment, and can be fabricated in virtually any shape. The systems of the present invention can be planar, non-planar, flexible, rigid, or any combination thereof. As such, the systems are suitable for adhering or placing on planar, non-planar, flat, curved, spherical, rigid, flexible, symmetric, and asymmetric objects and surfaces, and any combination thereof. In addition, the systems of the present invention can be placed on any object without limitation or reference to an object's surface roughness or surface waviness (i.e., the systems can be equally applied to smooth, rough and wavy surfaces or objects), and objects having heterogeneous surface morphology (i.e., objects having varying degrees of smoothness, roughness and/or waviness).

In some embodiments, the monitoring system is suitable for recording the temperature history of an object from −20° C. to 250° C., −20° C. to 220° C., −20° C. to 200° C., −20° C. to 180° C., −20° C. to 150° C., −20° C. to 125° C., −20° C. to 100° C., −20° C. to 80° C., 50° C. to 250° C., 50° C. to 220° C., 50° C. to 200° C., 50° C. to 180° C., 50° C. to 150° C., 50° C. to 125° C., or 50° C. to 100° C.

### Channels

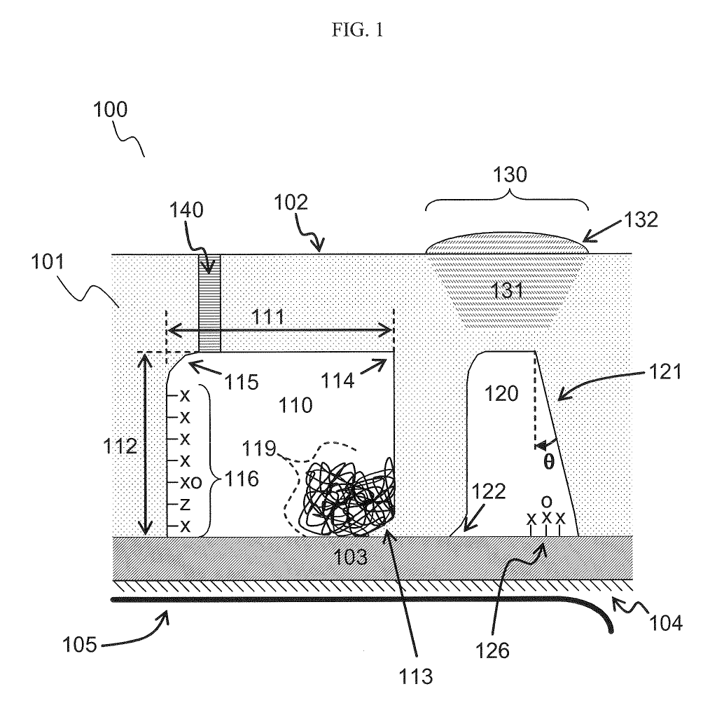

FIG. 1 provides a schematic cross-sectional representation of a portion of a system, 100, of the present invention that includes two channels. Referring to FIG. 1, provided is a system, 100, comprising a matrix, 101, having an outer surface, 102, and having a first channel, 110, and a second channel, 120, therein. Also included is a backing layer, 103, having an adhesive, 104, thereon, and including a peelable cover, 105, affixed thereto. The first channel, 110, has a substantially rectilinear cross-sectional shape and includes cross-sectional dimensions 111 and 112. The cross-section of the first channel, 110, includes corners, 113, 114 and 115, having tapered-inward, rectilinear, and tapered-inward shapes, respectively. The second channel, 120, has a trapezoidal shape in which one of the sidewalls, 121, forms an angle, θ, with the upper portion of the channel. The second channel, 120, also includes a tapered-outward corner, 122, formed between the matrix and the optional backing layer.

Referring to FIG. 1, in some embodiments, a portion of a channel is filled with a material, 119. Materials suitable for at least partially filling a channel include, but are not limited to, a natural and/or synthetic fibrous material (e.g., paper, non-woven fibers, cotton, cardboard, and the like), a polymer, a plastic, a metal (e.g., metal particles, a metal lattice, a porous metal, and the like), a glass (e.g., a porous glass, glass wool, and the like), a zeolite, a metal-organic framework, a reflective material, and combinations thereof. In some embodiments, a channel is at least partially filled with a portion of the matrix.

Not being bound by any particular theory, a material that at least partially fills a channel can function as: a wicking material (e.g., to promote flow of a thermally active material into a channel, a physical stabilizer of a channel, a chemical stabilizer of a thermally active material, a chemical reactant with a thermally stable material (e.g., to indicate a color change caused by reaction with a thermally active material), a reflective surface to promote visual observation of the progression of a thermally active material through a channel, and combinations thereof.

A sidewall of a channel can form an angle with another surface of a channel, or with a surface of a backing layer, of 30° to 160°, 45° to 150°, 60° to 120°, or 90°.

Referring to FIG. 1, one or more properties of the matrix, 101, and/or a surface thereof, 102, can be modified to enable viewing of a portion of a channel. For example, a system of the present invention can comprise a matrix portion positioned between a channel and an outer surface of a system, 131, which has a refractive index that is less than that of the matrix, 101. In some embodiments, an outer surface of the system can comprise one or more lens elements, 132, than enable easier viewing of a portion of a channel. A refractive index of a lens element, 132, can be the same or different than a material comprising the matrix.

In some embodiments, a channel and/or a reservoir of the present invention is in gaseous communication with an ambient atmosphere. As used herein, an “ambient atmosphere” refers to a gas or a mixture thereof that is present in an environment surrounding a system of the present invention at any given time. For example, when a system of the present invention is moved between different environments or locations either of an ambient pressure and/or makeup of the ambient atmosphere can change.

Referring to FIG. 1, system 100, can optionally include a vent, 140, suitable for maintaining an equilibrium or ambient pressure within an enclosed portion of the system, i.e., either of a channel and/or a reservoir. A vent can ensure that the systems of the present invention operate consistently at different ambient pressures. Optionally, instead of a vent, any of a matrix, an optional backing layer and/or an optional top layer can be permeable to an ambient gaseous environment such that a pressure within the fluidic channel(s) and/or a reservoir of the system are the same as an ambient pressure. The systems of the present invention are thus suitable for use among and between different ambient environments.

In some embodiments, thermal monitoring systems comprise “discrete layers” of material, which as used herein refers to layers that are separately formed as subcomponent of an overall structure.

As described in more detail below, the methods for producing fluidic structures provided herein can, in some embodiments, produce monolithic structures or discrete layered structures. In another embodiment, the fluidic structure includes two or more channels in a single matrix layer, or can include multiple layers of a matrix comprising one or more channels per matrix layer.

In some embodiments, a channel comprises one or more functional groups on at least a portion of a surface of the channel. In some embodiments, a channel comprises one or more hydrophilic functional groups on at least a portion of a surface of the channel. In some embodiments, a channel comprises one or more hydrophobic functional groups on at least a portion of a surface of the channel. Suitable functional groups for imparting hydrophobicity, hydrophilicity, or controlling an interaction between a surface of a channel and a thermally active material are described herein.

Referring again to FIG. 1, a surface of first channel, 110, is patterned with functional groups, 116 (i.e., “x”, “xo” and “z”), which are attached to a portion of the surface of the first channel corresponding to the matrix, 101. The functional groups can be intrinsic to a surface of matrix, optional backing layer, optional top layer, or a combination thereof, or any one of the surfaces can be functionalized, derivatized, or otherwise pre-treated to provide the functional groups on any one of these surfaces. Also shown is a surface of second channel, 120, which is patterned with functional groups, 126 (i.e., “x” and “xo”), which are attached to a portion of the surface of the optional backing layer, 103.

### Matrix and Backing Layer

The systems of the present invention comprise a matrix that at least partially defines the three-dimensional configuration of a channel. In some embodiments, a thermal monitoring system of the present invention comprises a stiff, rigid, flexible, deformable, porous and/or woven backing material. In some embodiments, an optional backing layer can define a surface of a channel, or at least a portion of a surface of a channel.

Materials suitable for use as a matrix and/or an optional backing layer include any material in and/or on which a thermally active material can be contained and/or supported. Materials for use as a matrix or as a backing material of the present invention can optionally include a derivatized surface comprising, e.g., a non-polar functional group, a polar functional group, a metal, and combinations thereof. Materials for use with the present invention can optionally include a surface coating thereon, such as, but not limited to, a metal, a high-density elastomer, a plastic, a fluoropolymer, a perfluoropolymer, and combinations thereof.

Materials suitable for use as a matrix and/or an optional backing layer are not particularly limited by composition and include materials chosen from metals, crystalline materials (e.g., monocrystalline, polycrystalline, and partially crystalline materials), amorphous materials, conductors, semiconductors, insulators, optics, fibers (e.g., woven or non-woven natural and/or synthetic fiber materials), glasses, ceramics, zeolites, polymers, plastics, thermosetting and/or thermoplastic materials (e.g., optionally doped: polyacrylates, polycarbonates, polyurethanes, polystyrenes, cellulosic polymers, polyolefins, polyamides, polyimides, resins, polyesters, polyphenylenes, and the like), films, thin films, foils, plastics, wood, minerals, biomaterials, alloys thereof, composites thereof, laminates thereof, porous variants thereof, doped variants thereof, and combinations thereof.

In some embodiments, a matrix comprises a material selected from: paper (including chromatographic paper, coated paper, and the like), a plastic, a glass, a polymer, an elastomer, a ceramic, a laminate thereof, and combinations thereof. In some embodiments, at least a portion of a matrix and/or a backing layer is conductive or semiconductive.

Plastics suitable for use with the present invention include those materials disclosed, for example but not limitation, in Plastics Materials and Processes: A Concise Encyclopedia, Harper, C. A. and Petrie, E. M., John Wiley and Sons, Hoboken, N.J. (2003) and Plastics for Engineers: Materials, Properties, Applications, Domininghaus, H., Oxford University Press, USA (1993), which are incorporated herein by reference in their entirety.

In some embodiments, a matrix and/or optional backing layer comprises a flexible material that is capable of being flexed, and/or undergoing elastic or plastic deformation, bending, compression, twisting, and the like in response to applied external force, stress, strain and/or torsion, and/or being rolled upon itself. Flexible materials suitable for use with the present invention include, but are not limited to, paper, polymers, woven fibers, thin films, metal foils, composites thereof, laminates thereof, and combinations thereof.

Elastomers suitable for use with the present invention include, but are not limited to silicone polymers (i.e., polymers having a —Si—O—Si— backbone that can be prepared, e.g., from alkyl-halosilane, alkoxysilane, alkyl-alkoxysilane, and/or alkoxy-halosilanes, and which include polydimethylsiloxane (“PDMS”) elastomers such as SYLGARD® elastomers, Dow Chemical Co., Midland, Mich.); epoxy polymers (i.e., polymers comprising a three-membered cyclic ether group commonly referred to as “epoxy,” “1,2-epoxide,” and “oxirane,” e.g., diglycidyl ethers of bisphenol A such as Novolac resins); polyamines (e.g., poly-aromatic amines); polyurethanes, resilins, elastins, polyimides, phenol-formaldehyde polymers, a natural rubber, a polyisoprene, a butyl rubber, a halogenated butyl rubber, a polybutadiene, a styrene butadiene, a nitrile rubber, a hydrated nitrile rubber, a chloroprene rubber (e.g., polychloroprene, available as NEOPRENE™ and BAYPREN®, Farbenfabriken Bayer AG Corp., Leverkusen-Bayerwerk, Germany), an ethylene propylene rubber, an epichlorohydrin rubber, a polyacrylic rubber, a silicone rubber, a fluorosilicone rubber, a fluoroelastomer, a perfluoroelastomer, a tetrafluoroethylene/propylene rubber, a chlorosulfonated polyethylene, an ethylene vinyl acetate, and the like; and combinations thereof. Flexible materials suitable for use with the present invention are also described in U.S. Pat. Nos. 5,512,131 and 5,900,160, which are incorporated herein by reference in their entirety.

In some embodiments, a surface of a matrix comprises a functional group on at least a portion thereof. The surface of a matrix can be functionalized after formation of the matrix, or a functional group present on a matrix surface can be obtained from reaction of a functional group-containing matrix precursor (e.g., a functional group present on a polymer precursor, a glass, or other matrix material). Functional groups suitable for use with the present invention include those known to persons of ordinary skill in the polymer and glass arts, as well as those described herein. In some embodiments, a functional group suitable for use with the present invention includes a moiety capable of interacting with a thermally active material (e.g., via a surface-surface interaction, and the like). In some embodiments, a matrix is substantially free of functional groups, which as used herein refers to a matrix substantially lacking terminal groups (e.g., a matrix comprising a substantially fully networked lattice).

An advantage for forming a matrix from a silicone polymer such as PDMS, is that these polymers can be oxidized, for example, by exposure to an oxygen-containing plasma (e.g., an air plasma), to provide structures having surface functional groups capable of cross-linking to other oxidized silicone polymer surfaces or to oxidized surfaces of a variety of other polymeric and non-polymeric materials. Thus, membranes, layers, and other structures produced according to the invention utilizing silicone polymers, such as PDMS, can be oxidized and essentially irreversibly sealed to other silicone polymer surfaces, or to the surfaces of other substrates reactive with the oxidized silicone polymer surfaces (e.g., glass, silicon, silicon oxide, quartz, silicon nitride, polyethylene, polystyrene, glassy carbon, and epoxy polymers), without the need for separate adhesives or other sealing means, for example, as described in U.S. Pub. No. 2005/0133741 A1, which is incorporated herein by reference in the entirety. In addition, microfluidic structures formed from oxidized silicone polymers can include channels having surfaces formed of oxidized silicone polymer, which surfaces can be much more hydrophilic than the surfaces of typical elastomeric polymers. Such hydrophilic channel surfaces can thus be more easily filled and wetted with aqueous solutions than can structures comprised of typical, unoxidized elastomeric polymers or other hydrophobic materials.

In some embodiments, a system comprises active elements, for example, integrated valves, pumping elements, and the like as described in, e.g., U.S. Pat. Nos. 6,645,432; 6,686,184; 6,767,194; 6,843,262; and 7,323,143, all of which are hereby incorporated by reference in their entirety.

In some embodiments, a material for use as a matrix and/or an optional backing layer is resistant to, or has a minimal solubility in, water, or in an aqueous solution, or in a solvent that a passive thermal monitoring system is likely to be exposed to during its useful lifetime such as, but not limited to, a lubricant, an oil, a silicone oil, an acidic solution, a basic solution, and combinations thereof. For example, a matrix can have a solubility of 1% or less, 0.1% or less, or 100 ppm or less, by weight, in an aqueous solution, or in a environment to which the thermal monitoring device is exposed.

In some embodiments, a material for use as a matrix and/or an optional backing layer undergoes a volume change of 10% or less over a temperature range of −20° C. to 250° C., and/or over a pressure range of 10 Torr to 800 Torr.

Generally, materials for use as a matrix and/or an optional backing layer are thermally stable. For example, in some embodiments a material undergoes a weight loss of 5% or less upon heating to a temperature of 250° C. In some embodiments, a material for use with the present invention undergoes a swelling (i.e., volume increase) of 10% or less upon heating to a temperature of 250° C.

In some embodiments, a material for use as a matrix is transparent or opaque to one or more wavelengths of electromagnetic radiation selected from the ultraviolet, visible, infrared, and microwave regions of the electromagnetic spectrum. In some embodiments, a matrix is transparent or opaque to visible light.

In some embodiments, a material for use a matrix and/or a backing layer has a Young's Modulus of 3 MPa or more, 5 MPa or more, 10 MPa or more, 15 MPa or more, 20 MPa or more, 30 MPa or more, 50 MPa or more, 100 MPa or more, 150 MPa or more, 250 MPa or more, 500 MPa or more, 750 MPa or more, 1 GPa or more, 1.25 GPa or more, 1.5 GPa or more, or 2 GPa or more.

In some embodiments, a matrix comprises a cross-linked polymer that does not have a melting point.

In some embodiments, the matrix comprises a polymer having a T_{g} of 100° C. or higher, 125° C. or higher, 150° C. or higher, 175° C. or higher, 200° C. or higher, 225° C. or higher, or 250° C. or higher.

In some embodiments, a matrix material is at least partially permeable to a gas (e.g., helium, neon, argon, nitrogen, oxygen, hydrogen, carbon dioxide, methane, and the like, and combinations thereof). Thus, in some embodiments a pressure within a channel and/or an optional reservoir can equilibrate with an ambient pressure of an atmosphere surrounding a system of the present invention due to one or more ambient gases permeating through the matrix to a channel and/or an optional reservoir.

In some embodiments, an optional backing material is at least partially light reflective in the visible region of the spectrum.

In some embodiments, the matrix, or a backing thereon comprises a self-adhesive layer. Self-adhesives suitable for use with the present invention include adhesives known to persons of ordinary skill in the art, and include pressure-sensitive adhesives, and adhesives that are stable up to 250° C. or higher.

### Thermally Active Materials and Functional Groups

As used herein, a “thermally active material” refers to a material that undergoes a phase change (e.g., a melting point transition) over a temperature range of 10° C. or less. In some embodiments, a thermally active material also possesses flow properties (e.g., viscosity) that are temperature dependent. In some embodiments, a thermally active material for use with the present invention undergoes a phase change at a temperature between −20° C. and 250° C.

Thermally active materials for use with the present invention include, but are not limited to, liquids, solids, semi-solids, colloids, gels, waxes, fats, oils, metals (e.g., solders), ionic liquids, oligomers, polymers, co-polymers, and combinations thereof.

In some embodiments, the thermally active material is water or comprises water.

In some embodiments, the thermally active material is inert. As used herein, “inert” refers to a material for use with the present invention being substantially free of functional groups, moieties, side groups, and the like capable of reacting with another functional group, moiety, or side group present on, e.g., a surface of a channel.

In some embodiments, a thermally active material suitable for use with the present invention undergoes thermal expansion in the liquid state. For example, in some embodiments a thermally active material undergoes a volume increase of 1% or more, 2% or more, or 5% or more for each increase of 10° C. above the melting point of the thermally active material.

In some embodiments, a thermally active material comprises a eutectic metal. In some embodiments, the thermally active material comprises a eutectic metal such as a solder. In some embodiments, a eutectic metal for use with the present invention comprises a mixture of one or more transition metals (e.g., cadmium, zinc, gold, nickel, iron, palladium, platinum, copper, silver, and the like, and combinations thereof) with an optional amount of aluminum, gallium, germanium, selenium, indium, tin, antimony, tellurium, lead and/or bismuth added thereto.

In some embodiments, a eutectic metal is selected from: a tin composition comprising 0.01% to 20% silver and 0.01% to 10% copper, by weight (e.g., SnAg₃Cu_{0.5}, SnAg_{3.5}Cu_{0.7}, SnAg_{3.5}Cu_{0.9}, SnAg_{3.8}Cu_{0.7}, SnAg_{3.9}Cu_{0.6}, and the like); a tin composition comprising 0.1% to 40% silver, 0.01% to 5% copper, and 0.01% to 5% antimony, by weight (e.g., SnAg_{3.8}Cu_{0.7}Sb_{0.25}, SuAg_{2.5}Cu_{0.8}Sb_{0.5}, and the like); a tin composition comprising 0.01% to 20% copper, by weight (e.g., SnCu_{0.7}, and the like); a tin composition comprising 1% to 20% zinc, by weight (e.g., SnZn₉, and the like); a tin composition comprising 1% to 50% zinc and 0.1% to 20% bismuth, by weight (e.g., SnZn₈Bi₃, and the like); a tin composition comprising 0.01% to 50% antimony, by weight (e.g., SnSb₅, and the like); a tin composition comprising 0.5% to 75% bismuth, by weight (e.g., SnBi₅₈, and the like); a tin composition comprising 0.5% to 75% bismuth and 0.01% to 20% silver, by weight (e.g., SnBi₅₇Ag₁, and the like); a tin composition comprising 0.5% to 75% indium, by weight (e.g., SnIn₅₂, and the like); a tin composition comprising 0.1% to 30% indium, 0.1% to 20% silver, and 0.1% to 10% bismuth (e.g., SnIn_{8.0}Ag_{3.5}Bi_{0.5}, and the like); a tin composition comprising 40% to 60% by weight of lead; and combinations thereof.

Additional non-limiting examples of solders suitable for use with the present invention include: 45% Bi/23% Pb/8% Sn/5% Cd/19% In (melting point of 47° C.), 50% Bi/25% Pb/12.5% Sn/12.5% Cd (melting point of 70° C.), 48% Sn/52% In (melting point of 118° C.), 42% Sn/58% Bi (melting point of 138° C.), 63% Sn/37% Pb (melting point of 183° C.), 91% Sn/9% Zn (melting point of 199° C.), 93.5% Sn/3% Sb/2% Bi/1.5% Cu (melting point of 218° C.), 95.5% Sn/3.5% Ag/1% Zn (melting point of 218°-221° C.), 99.3% Sn/0.7% Cu (melting point of 227° C.), 95% Sn/5% Sb (melting point of 232°-240° C.), 65% Sn/25% Ag/10% Sb (melting point of 233° C.), 97% Sn/2% Cu/0.8% Sb/0.2% Ag (melting point of 226°-228° C.), 77.2% Sn/20% In/2.8% Ag (melting point of 187° C.), 84.5% Sn/7.5% Bi/5% Cu/2% Ag (melting point of 212° C.), 81% Sn/9% Zn/10% In (melting point of 178° C.), 96.2% Sn/2.5% Ag/0.8% Cu/0.5% Sb (melting point of 215° C.), 93.6% Sn/4.7% Ag/1.7% Cu (melting point of 217° C.), and LMA-117 (melting point of 45° C.).

Additional thermally active materials suitable for use with the present invention include ionic liquids. In some embodiments, an ionic liquid suitable for use with the present invention has a melting point of −20° C. to 150° C., −20° C. to 120° C., −10° C. to 110° C., 0° C. to 100° C., or 10° C. to 90° C. Suitable ionic liquids include, but are not limited to, ethanolammonium nitrate, mixtures of a 1,3-dialkylimidazolium or a 1-alkylpyridinium halide with a trihalogenoaluminate, mixtures comprising a hexahalophosphate with an appropriate counter-ion, mixtures comprising a tetrahaloborate with an appropriate counter-ion, mixtures comprising an anion selected from: bistriflimide, triflate, tosylate, formate, alkylsulfate, and glycolate, with an appropriate counter-ion, and combinations thereof.

Additional thermally active materials suitable for use with the present invention include short-chain copolymers having a melting point of 200° C. or less (e.g., a copolymer of polyethylene and polyethylene glycol, and the like).

Additional thermally active materials suitable for use with the present invention include waxes, fats, oils, and combinations thereof. In some embodiments, the thermally active material comprises a wax, a fat and/or an oil selected from: an optionally substituted straight- or branched-chain C₈-C₈₀ alkane, an optionally substituted straight- or branched-chain C₈-C₈₀ alkene, an optionally substituted straight- or branched-chain C₈-C₈₀ alkyne, an optionally substituted C₈-C₈₀ cycloalkyl, an optionally substituted C₈-C₈₀ aryl, an optionally substituted C₈-C₈₀ heterocyclo, and combinations thereof. In some embodiments, the thermally active material comprises a wax, fat and/or oil selected from: an optionally substituted straight- or branched-chain C₁₀-C₃₀ alkane, an optionally substituted straight- or branched-chain C₁₀-C₃₀, alkene, an optionally substituted straight- or branched-chain C₁₀-C₃₀ alkyne, an optionally substituted C₁₀-C₃₀ cycloalkyl, an optionally substituted C₁₀-C₃₀ aryl, an optionally substituted C₁₀-C₃₀ heterocyclo, and combinations thereof. In some embodiments, the thermally active material comprises a wax, fat and/or oil selected from: an optionally substituted straight- or branched-chain C₁₂-C₂₄ alkane, an optionally substituted straight- or branched-chain C₁₂-C₂₄ alkene, an optionally substituted straight- or branched-chain C₁₂-C₂₄ alkyne, an optionally substituted C₁₂-C₂₄ cycloalkyl, an optionally substituted C₁₂-C₂₄ aryl, an optionally substituted C₁₂-C₂₄ heterocyclo, and combinations thereof.

As used herein, “alkane,” “alkyl” and “alk” alone or as part of another group refers to straight- and branched-chain saturated hydrocarbons and radicals thereof. Unless otherwise specified, an alkane or alkyl group can be optionally substituted with one or more optional substituents that can be the same or different at each occurrence. These substituents can occur at any place in any combination that provides a stable compound.

As used herein, “alkene” and “alkenyl” alone or as part of another group refers to straight- and branched-chain hydrocarbons and radicals thereof that comprise one or more —C═C— groups. Unless otherwise specified, an alkene or alkenyl group can be optionally substituted with one or more optional substituents that can be the same or different at each occurrence. These substituents can occur at any place in any combination that provides a stable compound.

As used herein, “alkyne” and “alkynyl” alone or as part of another group refers to straight- and branched-chain hydrocarbons and radicals thereof that comprise one or more —C≡C— groups. Unless otherwise specified, an alkyne or alkynyl group can be optionally substituted with one or more optional substituents that can be the same or different at each occurrence. These substituents can occur at any place in any combination that provides a stable compound.

As used herein, “cycloalkane” and “cycloalkyl” alone or as part of another group refers to saturated and partially unsaturated (i.e., containing one or more carbon-carbon double and/or triple bonds) cyclic hydrocarbon groups containing 1 to 3 rings, containing a total of 3 to 16 carbons forming the ring(s), and preferably containing 5 to 14 carbons forming the ring(s). Polycyclic systems may contain fused or bridged rings or both. In addition, a cycloalkyl group can be fused to 1 or 2 aryl rings. Unless otherwise specified, a cycloalkane or cycloalkyl group can be optionally substituted with one or more optional substituents that can be the same or different at each occurrence. These substituents can occur at any place in any combination that provides a stable compound.

As used herein, “aryl” alone or as part of another group refers to monocyclic, bicyclic, and tricyclic aromatic groups containing 6 to 24 carbons in the ring portion (such as, but not limited to, phenyl, naphthyl, anthryl, and phenanthryl) and can optionally include one to three additional rings fused to a cycloalkyl and/or heterocyclic ring(s). Unless otherwise specified, aryl groups can be optionally substituted with one or more optional substituents that can be the same or different at each occurrence. These substituents can occur at any place in any combination that provides a stable compound.

As used herein, “heterocyclic,” “heterocyclo,” and “heterocyclyl” alone or as part of another group refer to a monocyclic or multicyclic cycloalkyl and/or aryl ring systems wherein one or more of the ring atoms is an element other than carbon. Unless otherwise specified, heterocyclo groups can be optionally substituted with one or more optional substituents that can be the same or different at each occurrence. These substituents can occur at any place in any combination that provides a stable compound.

As used herein, “optionally substituted” refers to a thermally active material and/or at least a portion of a surface of a channel that bears a “functional group,” or is otherwise “optionally substituted.” As used herein, “optional substituents” include hydrophilic, hydrophobic, and other functional groups selected from:

halo (i.e., —F, —Cl, —Br or —I);

perhhalo (e.g., CF₃, C₂F₅, and the like);

C₁-C₄ alkyl (e.g., —CH₃, —C₂H₅, n-C₃H₇, iso-C₃H₇, cyclic —CH(CH₂)₂, n-C₄H₉, iso-C₄H₉, sec-C₄H₉, tent-C₄H₉, cyclic —CH₂—CH—(CH₂)₂, cyclic —CH—(—CH₂—)(—CH(CH₃)—), or cyclic —CH—(—CH₂—)₃, or an unsaturated or partially unsaturated variant thereof);

hydroxyl (e.g., —OH);

ether (e.g., —OR′), wherein R′ is a C₁-C₁₀ straight, branched or cyclic alkyl, alkenyl, alkynyl, cycloalkyl, aryl, or heterocyclo, any of which can be optionally substituted with 1-3 occurrences of R²³;

acyl (e.g., —C(═O)R), wherein R is selected from: H, F, Cl, and a C₁-C₁₀ straight, branched or cyclic alkyl, alkenyl, alkynyl, cycloalkyl, aryl, or heterocyclo, any of which can be optionally substituted with 1-3 occurrences of R²³;

acyl ether (e.g., —O—C(═O)R), wherein R is as defined above;

acyl ester (e.g., —OC(═O)OR), wherein R is as defined above;

amino (—NRR¹), wherein R and R¹ are independently the same or different and are selected from: H and a C₁-C₁₀ straight, branched or cyclic alkyl, alkenyl, alkynyl, cycloalkyl, aryl, or heterocyclo, any of which can be optionally substituted with 1-3 occurrences of R²³;

acid amino (e.g., —NR—C(═O)OR¹), wherein R and R¹ are independently the same or different and are as defined above;

carboxyl (e.g., —C(═O)OR), wherein R is defined above;

amino acyl (e.g., —C(═O)—NRR¹), wherein R and R¹ are independently the same or different as defined above;

sulfonic acid (e.g., —S(═O)₂OH);

sulfonyl (e.g., —S(═O)₂—X), wherein X is a halide, or R as defined above;

thiol (e.g., —SR), wherein R is defined above;

thionyl (e.g., —S(═O)—X), wherein X is a halide, or R as defined above;

phosphonic acid (e.g., —P(═O)(OH)₂);

phosphonyl (e.g., —P(═O)₂R, wherein R is as defined above;

nitro (i.e., —NO₂);

cyano (i.e., —C≡N);

iso-cyano (i.e., —N⁺≡C⁻);

—C(═O)NRR¹, wherein R and R¹ are independently the same or different as defined above;

—S(═O)₂NRR¹, wherein R and R¹ are independently the same or different as defined above;

—S(═O)₂N(H)C(═O)R, wherein R is as defined above;

—S(═O)₂N(H)C(═O)R, wherein R is as defined above;

—N(R)S(═O)₂R¹, wherein R and R¹ are independently the same or different as defined above;

—N(R)C(═O)ₓR¹, wherein x is 1 or 2, and R and R¹ are independently the same or different as defined above;

—N(R)C(═O)NR¹R², wherein R and R¹ are independently the same or different as defined above, and R² is selected from: H, F, and a C₁-C₁₀ straight, branched or cyclic alkyl, alkenyl, alkynyl, cycloalkyl, aryl, or heterocyclo, any of which can be optionally substituted with 1-3 occurrences of R²³;

—N(R)—S(═O)₂NR¹R², wherein R, R¹, and R² are independently the same or different as defined above;

—OC(═O)NRR¹, wherein R and R¹ are independently the same or different as defined above;

—C(═O)N(R)S(═O)₂NR¹R², wherein R, R¹, and R² are independently the same or different as defined above;

—C(═O)N(R)S(═O)₂R¹, wherein R and R¹ are independently the same or different as defined above;

oxo (i.e., ═O);

thioxo (i.e., ═S);

imino (i.e., ═NR), wherein R is as defined above

—N(R)C(═NR¹)R², wherein R, R¹, and R² are independently the same or different as defined above;

—N(R)C(═(NR¹)NR²R³, wherein R, R¹, and R² are different as defined above, and R³ is selected from: H, F, and a C₁-C₁₀ straight, branched or cyclic alkyl, alkenyl, alkynyl, cycloalkyl, aryl, or heterocyclo, any of which can be optionally substituted with 1-3 occurrences of R²³;

—C(═NR)NR¹R², wherein R, R¹, and R² are independently the same or different as defined above;

—O—C(═NR)NR¹R², wherein R, R¹, and R² are independently the same or different as defined above;

—O—C(═NR)R¹, wherein R and R¹ are independently the same or different as defined above;

—C(═NR)R¹, wherein R and R¹ are independently the same or different as defined above;

—C(═NR)—OR¹, wherein R and R¹ are independently the same or different as defined above;

siloxyl (e.g., —Si(OR)ₓ(OR¹)_{y}(OR²)_{z}, wherein R, R¹, and R² are independently the same or different as defined above, and x, y and z are independently integers ranging from 0 to 3, and x+y+z═3);

mono-silyl (e.g., —Si(R)ₓ(OR¹)_{y}(OR²)_{z}, wherein R, R¹, and R² are independently the same or different as defined above, and x, y and z are independently integers ranging from 0 to 3, and x+y+z=3);

di-silyl (e.g., —Si(R)ₓ(R¹)_{y}(OR²), wherein R, R¹, and R² are independently the same or different as defined above, and x, y and z are independently integers ranging from 0 to 3, and x+y+z=3); and

tri-silyl (e.g., —Si(R)ₓ(R¹)_{y}(R²)_{z}, wherein R, R¹, and R² are independently the same or different as defined above, and x, y and z are independently integers ranging from 0 to 3, and x+y+z=3).

As used herein, “R²³” is a group chosen from: halo; perhalo; nitro; cyano; iso-cyano, —OR³¹; hydroxy; lower alkoxy; cyano, isocyano, carbomethoxy; —SR³¹; —C(═O)OR³¹; —C(═O)R³¹; —C(═O)NR³¹R³¹; —S(═O)₂NR³¹R³¹; —NR³¹R³¹; —N(R³¹)S(═O)₂R³¹; —N(R³¹)C(O)ₓR³¹ (wherein x is 1 or 2); —N(R³²)C(═O)NR³¹R³¹; —N(R³¹)S(═O)₂NR³¹R³¹; —OC(═O)R³¹; —OC(═O)OR³¹; —S(═O)₂R³¹; —S(═O)₂N(R³¹)C(═O)R³¹; —S(═O)₂N(R³¹)C(═O)OR³¹; —C(═O)N(R³¹)SO₂NR³¹R³¹; —C(═O)N(H)SO₂R³¹; —OC(═O)NR³¹R³¹; —NR³¹—C(═NR³¹)R³¹; —NR³¹—C(═NR³¹)OR³¹; —NR³¹—C(═NR³¹)NR³¹R³¹; —C(═NR³¹)NR³¹R³¹; —OC(═NR³¹)R³¹; —OC(═NR³¹)NR³¹R₃₁; and —C(═NR³¹)OR³¹.

As used herein R³¹ is H or a C₁-C₄ alkyl (e.g., —CH₃, —C₂H₅, n-C₃H₇, iso-C₃H₇, cyclic —CH(CH₂)₂, n-C₄H₉, iso-C₄H₉, sec-C₄H₉, tert-C₄H₉, cyclic —CH₂—CH—(CH₂)₂, cyclic —CH—(—CH₂—)(—CH(CH₃)—), or cyclic —CH—(—CH₂—)₃), or an unsaturated or partially unsaturated variant thereof, wherein for terminal groups comprising two or more occurrences of R³¹, the two or more R³¹ groups are independently the same or different.

The optional substituents and functional groups described herein include all stereoisomers, either in admixture or in pure or substantially pure form. The optional substituents and functional groups for use with the present invention can have asymmetric centers at any of the carbon atoms including any one or the R, R′, R¹, R², R³, R²³ (and/or R³¹ substituents. Consequently, the optional substituents and functional groups can be present in enantiomeric or diastereomeric forms or in mixtures thereof. The methods for preparing the systems of the present invention can utilize racemates, enantiomers or diastereomers as the thermally active materials.

In some embodiments, a thermally active material comprises a wax, oil, or fat having one or more hydrophilic functional groups. Hydrophilic waxes, oils and fats for use with the present invention include, but are not limited to C₈-C₈₀, C₁₀-C₃₀ and C₁₂-C₂₄ compounds comprising one or more hydrophilic functional groups.

As used herein, a “hydrophilic” functional group refers to a chemical functional group that when chemically bound to a compound, increases the solubility in water of the compound compared to a C—H bond, or when attached to a surface, decreases the contact angle of water on the surface compared to a surface comprising a similar concentration of C—H bonds. Suitable hydrophilic optional substituents include, but are not limited to, —OH, —C(═O)OH, amino, sulfonyl, phosphonyl, and the like, as well as charged functional groups (e.g., quaternary amine groups). In some embodiments, a hydrophilic functional group has at least one N and/or O atom capable of forming a hydrogen bond.

In some embodiments, a channel comprises one or more acid or basic functional groups suitable for reacting with a thermally active material and/or a colorant that is mixed with a thermally active material. For example, an acid functional group present in a channel can react with a colorant such as a dye molecule to induce a color change in the thermally active material as it flows into a channel.

In some embodiments, a thermally active material comprises a hydrophobic wax, oil, or fat. Hydrophobic waxes, oils and fats for use with the present invention include, but are not limited to unsubstituted C₈-C₈₀, C₁₀-C₃₀ and C₁₂-C₂₄ compounds, as well as C₈-C₈₀, C₁₀-C₃₀ and C₁₂-C₂₄ compounds comprising one or more hydrophobic functional groups.

As used herein, a “hydrophobic” functional group refers to a chemical functional group that when chemically bound to a compound, decreases the solubility in water of the compound compared to a C—H bond, or when attached to a surface, increases the contact angle of water on the surface compared to a surface comprising a similar concentration of C—H bonds. Suitable hydrophobic optional substituents include, but are not limited to, halo, perhalo, siloxyl, mono-silyl, di-silyl, tri-silyl, and combinations thereof and unsubstituted: alkyl, alkenyl, alkynyl, aryl and heterocyclyl, groups (as defined above), and combinations thereof.

Substituted alkyl, alkenyl, alkynyl, aryl, arylalkyl, heterocyclyl, and alkylsilyl groups (as defined above), can also be suitable for imparting hydrophobicity to a surface of a channel, wherein the functional groups present in the material are not exposed at the surface of the pattern. For example, hydrogen-bond donating and accepting groups, and the like, can be present in the backbone of a functional group attached to a surface of a channel.

The present invention also includes thermally active materials that are present as salts (e.g., addition salts) of any of the materials described herein. Hydrated forms of salts can also be utilized without limitation. A salt can be formed by adding an appropriate acid or base to a thermally active material. In some embodiments, a salt of a thermally active material has a melting point of −30° C. to 250° C., −20° C. to 250° C., −10° C. to 250° C., 0° C. to 250° C., 10° C. to 250° C., 20° C. to 250° C., 35° C. to 225° C., 40° C. to 200° C., 45° C. to 190° C., or 50° C. to 180° C. In some embodiments, a thermally active material comprises a carboxylate group present as a salt, wherein the salt form of the thermally active material has a melting point of 30° C. to 180° C.

In some embodiments, the thermally active material comprises a salt of a C₂-C₂₂ compound (e.g., an alkane, alkene, alkyne, cycloalkane, aryl or heterocyclic compound) having a melting point of −20° C. to 200° C. Suitable salts include, acid addition salts, alkali metal salts, alkali earth metal salts, transition metal salts, halogen salts, and the like, and combinations thereof.

Thermally active materials suitable for use with the present invention are not limited by viscosity so long as the material is capable of flowing in, on or through a channel. Generally, a thermally active material has a viscosity that varies over a temperature range of −20° C. to 250° C. (due to, e.g., melting, softening, undergoing a chemical reaction, and the like). In some embodiments, viscosity over a temperature range of −20° C. to 250° C. can be 10 cP to 1×10¹² cP.

In some embodiments, a thermally active material is selected based on its viscosity at a temperature above its melting point. Parameters that can influence viscosity include, but are not limited to, molecular weight, the presence of functional groups capable of intra- or inter-molecular hydrogen bonding interaction(s), oligomer and/or polymer length, oligomer and/or polymer molecular weight, and combinations thereof. In some embodiments, the viscosity of a thermally active material can be modified for example, by controlling the pH within a channel and/or an optional reservoir.

In some embodiments, a thermally active material is substantially pure. As used herein, “substantially pure” refers to a thermally active material having a purity of 95% or higher, 98% or higher, 99% or higher, 99.5% or higher, 99.9% or higher, or 99.99% or higher.

In some embodiments, a “substantially pure” material consists essentially of a single molecule. In some embodiments, a “substantially pure” material consists of an oligomer or a polymer having a narrow molecular weight distribution. For example, in some embodiments an oligomer or a polymer suitable for use with the present invention has an average molecular weight distribution, M_{w}, of 20,000 Da or less, 10,000 Da or less, 5,000 Da or less, 1,000 Da or less, 500 Da or less, 250 Da or less, or 100 Da or less.

In some embodiments, a substantially pure oligomer or polymer suitable for use with the present invention has a melting point range of 20° C. or less, 15° C. or less, 10° C. or less, 5° C. or less, or 2° C. or less.

In some embodiments, the thermally active material absorbs at least one wavelength of visible light. In some embodiments, the thermally active material absorbs at least a wavelength of visible light and reflects another wavelength of visible light.

In some embodiments, a colorant or indicator is present with the thermally active material. As used herein, a “colorant” and “indicator” refer to an additive (e.g., a compound or molecule) that absorbs light in the visible region of the spectrum, and thus can aid in the identification of the distance within a channel that is traversed by a thermally active material.

In some embodiments, a colorant is present in a trace concentration with the thermally active material in a concentration sufficient to provide a visible hue to the thermally active material, but in a concentration that does not substantially alter the thermal properties of the thermally active material. In some embodiments, a colorant or indicator is present in a trace amount, a concentration of 100 ppm or less, 10 ppm or less, or 1 ppm or less. Other suitable concentrations for a colorant include 0.0001% to 5%, 0.0005% to 2%, 0.001% to 1%, 0.005% to 0.5%, or 0.01% to 0.2% by weight of the thermally active material.

### Structures

The present invention is directed to a passive thermal monitoring system comprising a matrix including at least a first channel therein, wherein the first channel has a cross-sectional area; and at least a first thermally active material having a melting point within:

a first range of −20° C. to 50° C., or

a second range of 51° C. to 100° C., or

a third range of 101° C. to 150° C., or

a fourth range of 151° C. to 200° C., or

a fifth range of 201° C. to 250° C.;

wherein the first thermally active material is positioned to be in fluid communication with at least the first channel in a fluid state, and wherein a flow of the first thermally active material in a fluid state into and through at least the first channel occurs only above a threshold temperature characteristic of an interaction between the first thermally active material and the first channel.

In some embodiments, a first channel comprises a hydrophobic functional group. In some embodiments, the first functional group comprises a mixture of one or more functional groups in a patterned or a random distribution within and/or the channel. In some embodiments, the first functional group comprises a mixture of alkyl and alkylsilyl functional groups.

In some embodiments, the first thermally active material is an optionally substituted hydrophobic alkane having a purity of 99% or greater, and the first functional group is a hydrophobic functional group (e.g., unsubstituted alkyl, alkylsilyl, unsubstituted aryl, perhalo alkyl, halo, and the like, and combinations thereof).

In some embodiments, the passive thermal monitoring system comprises a second thermally active material having a melting point within one of a first range through fifth ranges, wherein the melting points of the first and the second thermally active materials are in different ranges, wherein the second thermally active material is in fluid communication with at least a second channel in a fluid state, and wherein a flow of the second thermally active material in a fluid state into and through at least the second channel occurs only above a threshold temperature characteristic of an interaction between the second thermally active material and the second channel.

In some embodiments, the second channel comprises a second functional group. The second functional group can be the same or different as the first functional group. In some embodiments, the second functional group comprises a mixture of one or more functional groups in either of a patterned or a random distribution.

In some embodiments, a second thermally active material is a optionally substituted hydrophilic alkane bearing at least one hydrophilic functional group and having a purity of 99% or greater.

In some embodiments, the passive thermal monitoring system comprises a third thermally active material having a melting point within one of a first through fifth ranges, wherein the melting points of the first, second, and third thermally active materials are in different ranges, wherein the third thermally active material is in fluid communication with at least a third channel in a fluid state, and wherein a flow of the third thermally active material in a fluid state into and through at least the third channel occurs only above a threshold temperature characteristic of an interaction between the third thermally active material and the third channel.

In some embodiments, the third channel comprises a third functional group. The third functional group can be the same or different as the first and second functional groups. In some embodiments, the third functional group comprises a mixture of one or more functional groups in either of a patterned or a random distribution.

In some embodiments, the third thermally active material is a eutectic metal, and the third functional group is a hydrophilic functional group (e.g., a thiol, a hydroxyl, a carboyxl, an amine, and the like, and combinations thereof).

In some embodiments, the passive thermal monitoring system comprises a fourth thermally active material having a melting point within one of a first through fifth ranges, wherein the melting points of the first, second, third, and fourth thermally active materials are in different ranges, wherein the fourth thermally active material is in fluid communication with at least a fourth channel in a fluid state, and wherein a flow of the fourth thermally active material in a fluid state into and through at least the fourth channel occurs only above a threshold temperature characteristic of an interaction between the fourth thermally active material and the fourth channel.

In some embodiments, the fourth channel comprises a fourth functional group. The fourth functional group can be the same or different as the first, second and third functional groups. In some embodiments, the fourth functional group comprises a mixture of one or more functional groups in either of a patterned or a random distribution.

In some embodiments, the fourth thermally active material is a eutectic metal, and the fourth functional group is a hydrophilic functional group (e.g., a thiol, a hydroxyl, a carboyxl, an amine, and the like, and combinations thereof).

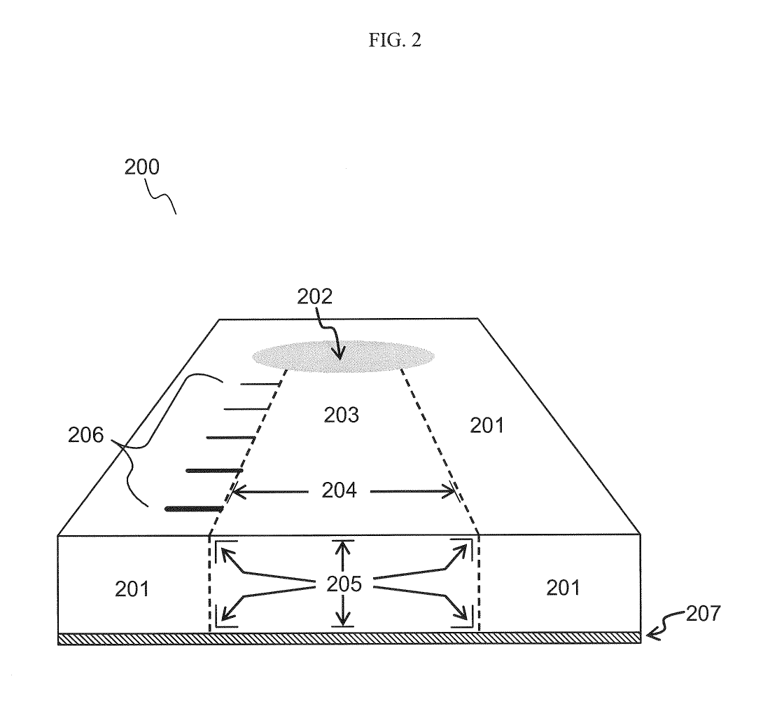

FIG. 2 provides a three-dimensional schematic representation, 200, of a passive thermal monitoring system of the present invention. Refuting to FIG. 2, the passive thermal monitoring system comprises a matrix, 201, a first thermally sensitive material, 202, and a first channel, 203, having a lateral dimension (i.e., a width), 204, and a cross-sectional area, 205. The thermally active material, 202, is in fluid communication with the first channel, 203, in a fluid state. The first channel, 203, can include one or more functional groups on the surface of the channel and/or within the channel. For example, a channel filled with a material as depicted in FIG. 2, can include one or more functional groups on an interior portion of a channel and/or on a material that fills the channel. The system also includes a plurality of hashmarks, 206, to indicate the distance that a thermally sensitive material, 202, flows into the channel, 203. The system also includes an optional backing layer, 207.

The present invention is also directed to a passive thermal monitoring system comprising a matrix that includes a plurality of channels therein, wherein each channel has an independent cross-sectional area of 10 mm² or less, and at least a portion of a surface of one or more of the channels includes one or more functional groups thereon that are the same or different; and a thermally active material, wherein the thermally active material is positioned to be in fluid communication with the plurality of channels in a fluid state; wherein a flow of the thermally active material in a fluid state into one or more of the channels from the reservoir is temperature dependent and occurs above a threshold temperature characteristic of an individual channel, wherein the thermally active material in a fluid state progresses through one or more of the channels above the threshold temperature, and wherein the threshold temperature at which the thermally active material flows into and then progresses through each of the individual channels is different.

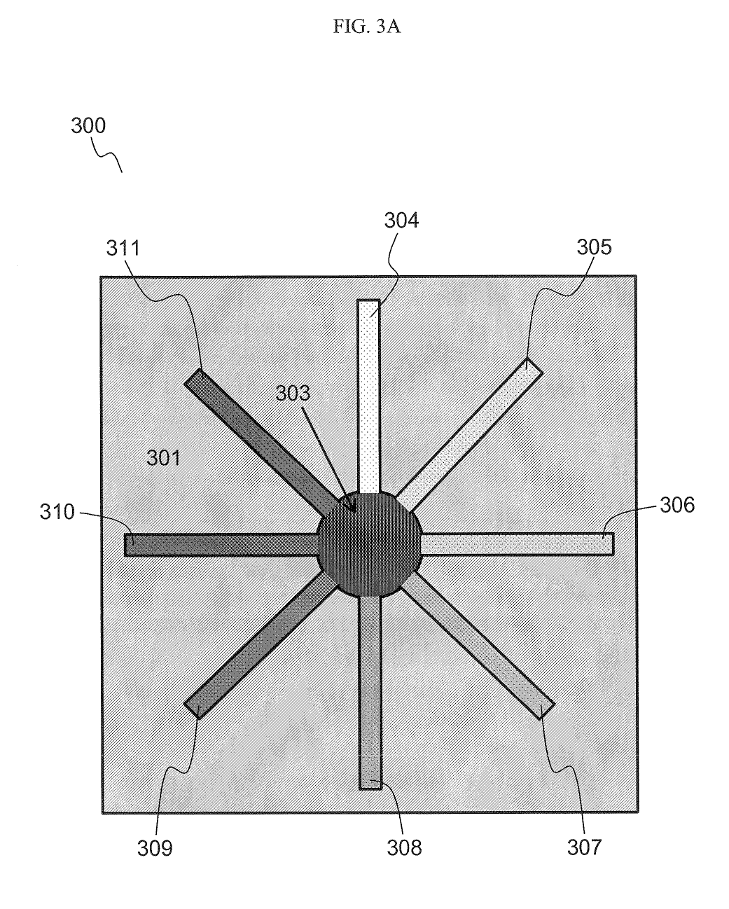

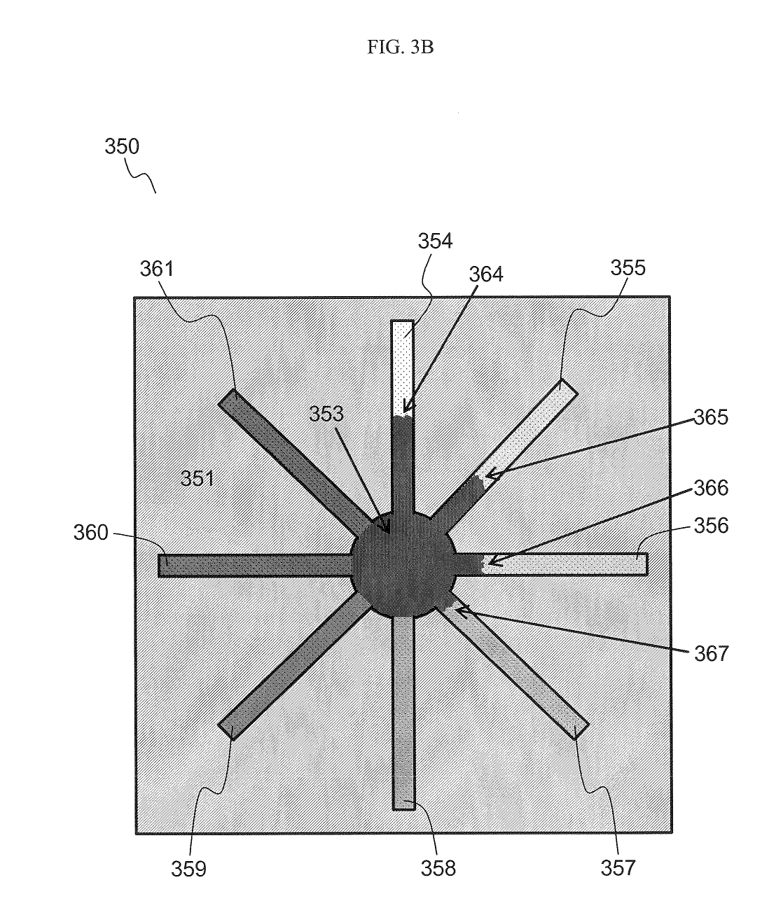

FIG. 3A provides a top-view schematic representation of a passive thermal monitoring system, 300, of the present invention. Referring to FIG. 3A, a system 300, is depicted having a matrix, 301, that comprises a thermally active material, 303. Fluidically connected to the thermally active material, 303, are channels, 304, 305, 306, 307, 308, 309, 310 and 311, which fluidically isolated from each other. The channels, 304-311, each can comprise different functional groups on and/or in the channels, which is graphically depicted as a difference in coloration of channels 304-311, respectively. The flow of the thermally active material, 303, into a channel is dependent on an interaction between the thermally active material contained within the reservoir and the functional groups present on a surface of each channel. In this embodiment, an interaction between the thermally active material, 303, and the channels, 304-311, is such that the threshold temperature at which the thermally active material flows into each of the channels increases incrementally from channel 304 to channel 311, respectively (i.e., the temperature at which the thermally active material flows into channel 304<305<306<307<308<309<310<channel 311).

FIG. 3B provides a top-view schematic representation of the passive thermal monitoring system provided in FIG. 3A, 300, after the system has been exposed to a temperature event. Referring to FIG. 3B, in response to a temperature event, thermally active material, 353, has flowed into at least a portion of channels, 354, 355, 356, and 357, to distances of 364, 365, 366, and 367, respectively.

The distance traversed by the thermally active material into each channel is characteristic of the time that the system, 350, was exposed to a threshold temperature characteristic of each channel. For example, the distance traversed, 364, 365, 366, and 367, by the thermally active material, 353, in each of channels, 354, 355, 356, and 357, respectively, corresponds to the duration that the system was exposed to a temperature at or above the characteristic temperature of each of the channels. Thus, the duration that the system was exposed to the temperate at which thermally active material, 353, flowed into channel 354, was longer in duration that the temperate at which thermally active material, 353, flowed into channel 355 (and 355<356<357, respectively). Furthermore, after the ambient temperature fell below the characteristic temperature of each channel, 354-361, the distance that the thermally active material traversed (or did not traverse) into each channel was recorded within each of the channels for visual identification. Thus, the location of the thermally active material, 353, in the plurality of channels was stationary below the threshold temperature characteristic of each of the channels 354-357, respectively.

In some embodiments, a functional group present on the surface of a channel interacts with a thermally active material, a chemical functional group thereon, or a component thereof, and the interaction induces at least one of a color change, a change in refractive index, a change in reflectance, or a combination thereof, on a portion of a channel. In some embodiments, an interaction can comprise a chemical reaction between the thermally active material and a functional group. Other interactions include, but are not limited to, a wetting of a surface comprising a functional group by the thermally active material, a hydrogen-bonding interaction between a functional group and a thermally active material, an ionic interaction between a functional group and a thermally active material, and the like.

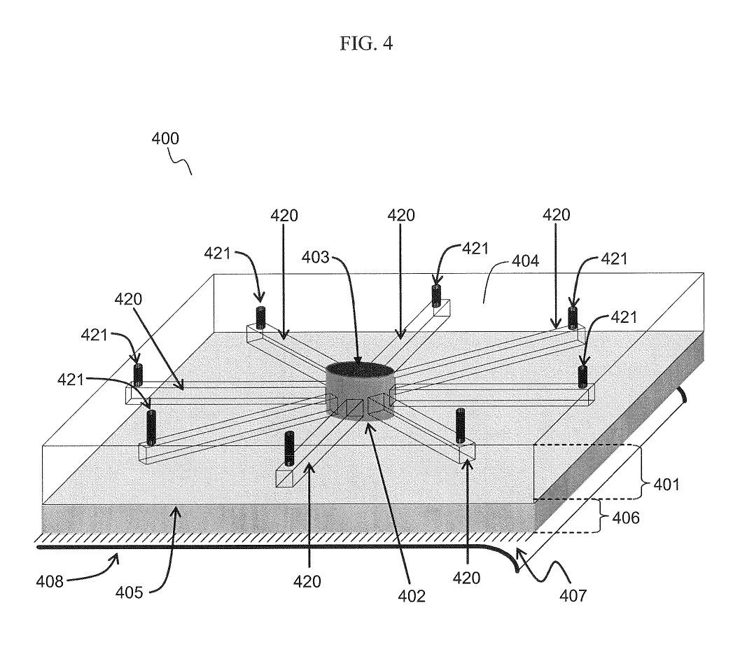

FIG. 4 provides a three-dimensional schematic representation of a passive thermal monitoring system, 400, of the present invention similar to that depicted in FIGS. 3A-3B. Referring to FIG. 4, the system, 400, comprises a matrix, 401, that includes an optional reservoir, 402, which contains a thermally active material, 403. The optional reservoir, 403, is fluidically connected to channels, 420. The matrix, 401, has a top-side, 404, and a back-side, 405, the latter of which is attached (e.g., adhered) to a backing layer, 406. The backing layer, 406, has a self-adhesive, 407, applied thereto, and a peelable backing layer thereon, 408. The channels, 420, include a vent, 421, that places the interior space of the channels in gaseous communication with an outer surface of the matrix, 404.

While the vent, 421, depicted in FIG. 4 is cylindrical in shape, any shape suitable for placing at least a portion of the channel in gaseous communication with an ambient atmosphere is suitable. Furthermore, a vent, 421, can be “empty” or comprise one or more filler materials, such as a porous membrane, a glass material, a plastic, a particulate, a colloid, and the like, and combinations thereof, so long as the material is gas-permeable. Additionally, an optional vent can be placed at any point along a channel, and a single channel can include multiple vents. The vent can be permeable or impermeable to a thermally active material.

In some embodiments, one or more of the channels is fluidly connected to the reservoir at both ends of the channel. FIG. 5 provides a top-view schematic representation of a passive thermal monitoring system of the present invention, 500. The system, 500, comprises a matrix, 501, that includes an optional reservoir, 502, containing a thermally active material, 503. The optional reservoir, 502, is fluidically connected to channels, 504, 505, 506, 507, 508 and 509. The channels, 504-509, each can comprise different functional groups within and/or on the channels, as is indicated by the differences in coloration of channels 504-509, respectively. As shown, the one or more channels of the system, 504-509, are in fluid communication with the optional reservoir at one end of the channels, 510, and are fluidically isolated from each other. Furthermore, the channels, 504-509, are in partial fluid communication (i.e., are gaseously connected) to the optional reservoir at a second end of the channels, 511, such that an internal pressure within the system can remain substantially constant when a thermally active material flows into or more of the channels. The gaseous connection between a channel and a reservoir, 511, can comprise a material that is permeable to a gaseous compound, element, molecule, and/or moiety present within the channels and/or reservoir, but impermeable to the thermally active material, 503. Materials suitable for use as a vent filler (e.g., membranes, porous materials, glasses, colloids, and the like) can also be used as an internal barrier that enable gaseous communication between a channel and reservoir, but prevent flow of a thermally active material from the reservoir into a channel.

The present invention is also directed to a passive thermal monitoring system comprising a matrix that includes a channel therein having an opening and a terminus, wherein the channel comprises a plurality of fluidly connected segments, each segment having a cross-sectional area of 10 mm² or less; and a thermally active material having a melting point of 20° C. to 250° C., wherein the thermally active material is positioned to be in fluid communication with the beginning of the channel in a fluid state, wherein a flow of the thermally active material in a fluid state into the channel is temperature dependent and occurs only above a threshold temperature characteristic of an interaction between the thermally active material and the beginning of the channel, wherein a rate of flow of the thermally active material in a fluid state into each segment of the channel is temperature dependent above a threshold temperature characteristic of each segment of the channel and occurs only above a threshold temperature characteristic each segment of the channel, wherein a rate of flow of the thermally active material in a fluid state through one or more segments of the channel is temperature independent above the threshold temperature characteristic of the segment of the channel, and wherein the characteristic temperature of each segment of the channel is different and increases as the distance of each segment from the opening of the channel increases.

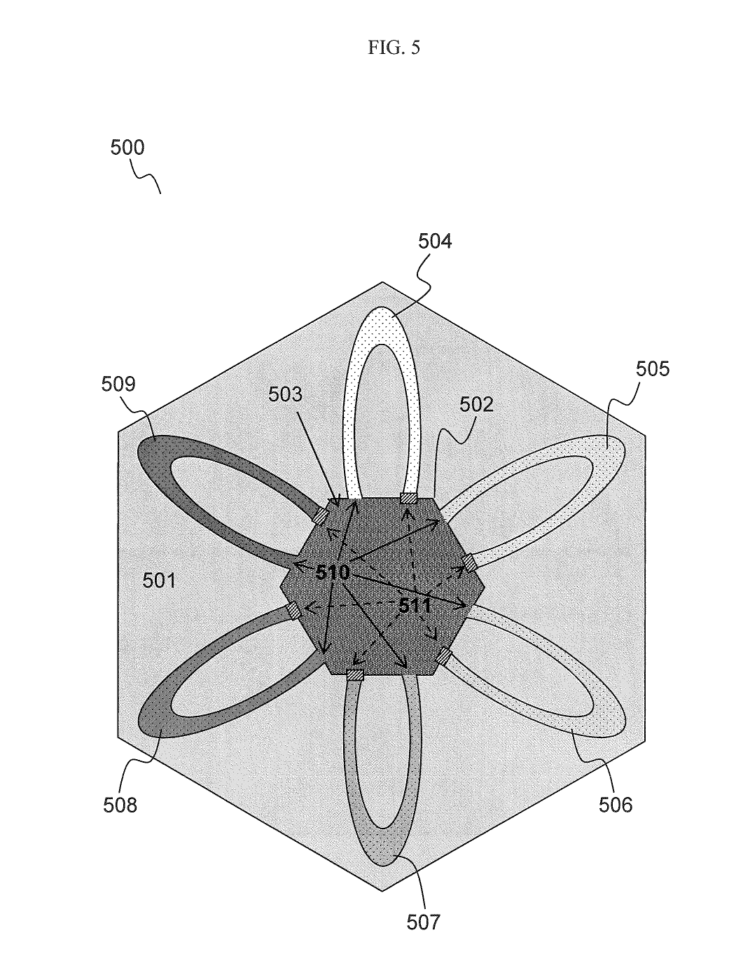

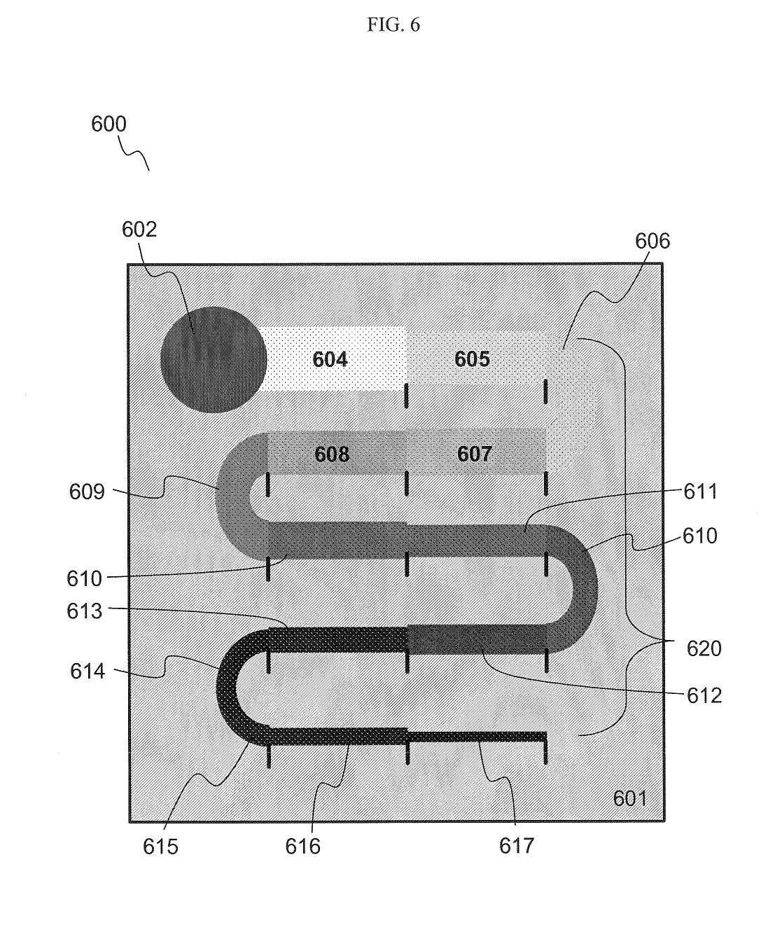

In some embodiments, the flow into and the rate of flow of the thermally active material through one or more of the channels is dependent on at least the independent cross-sectional area of the channel. FIG. 6 provides a top-view schematic representation of a passive thermal monitoring system, 600, of the present invention. Referring to FIG. 6, the system, 600, comprises a matrix, 601, that includes a thermally active material, 602. The thermally active material is in fluid communication with a channel, 620, comprising segments, 604-617. The channel segments, 604-617, can comprise different functional groups within each segment, as is represented by differences in coloration of segments 604-617, respectively. As shown, the first segment, 604, is in fluid communication with the thermally active material, 602, at one end and fluidically connected to a second segment, 604, at a second end of the segment. The flow of the thermally active material, 602, into channel segment 604 can be dependent on either/both an interaction between the thermally active material and the functional groups present within the first segment and/or a cross-sectional dimension of the first segment. In this embodiment, an interaction between the thermally active material, 602, and the channel segments, 604-617, is such that the threshold temperature at which the thermally active material flows into each segment of the channel increases incrementally from segment 604 to segment 617, respectively (i.e., the temperature at which the thermally active material flows into segment 604<605<606<607<608<609<610<611<612<613<614<615<616<segment 617).

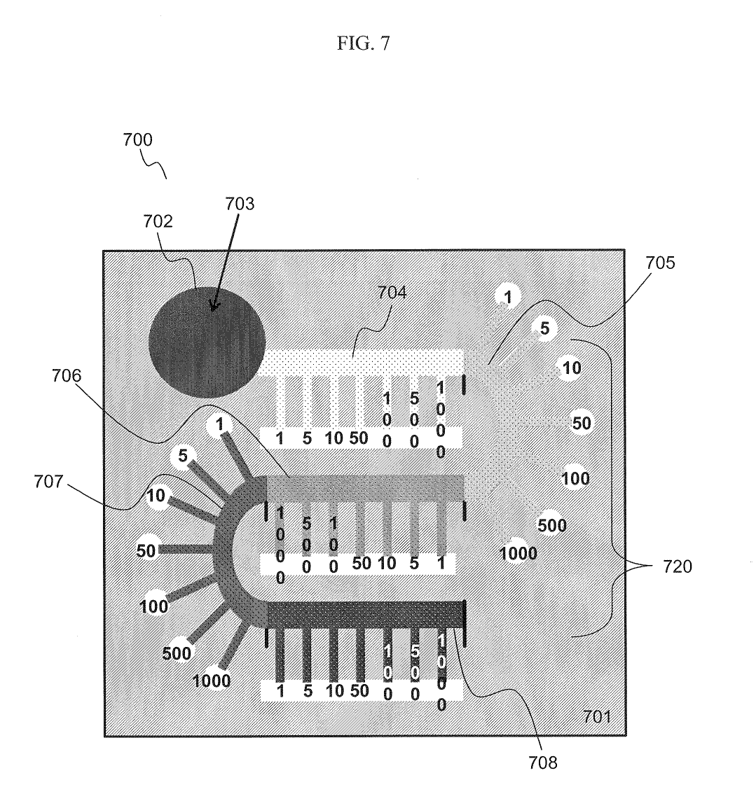

In some embodiments, one or more of the segments comprises a plurality of capillary channels (also referred to herein as “side channels”) extending from a surface of the segment, wherein a rate of flow of the thermally active material into and through each capillary channel of a segment of the channel is different and depends on at least one of: an ambient temperature, a functional group on a surface of the capillary channel, and a cross-sectional area of the capillary channel. FIG. 7 provides a top-view schematic representation of a passive thermal monitoring system, 700, of the present invention. Referring to FIG. 7, the system, 700, comprises a matrix, 701, that includes an optional reservoir, 702, that contains a thermally active material, 703. The optional reservoir is in fluid communication with a channel, 720, comprising segments, 704-708. The channel segments, 704-708, each can comprise different functional groups within and/or on the segments, as is depicted graphically by the differences in coloration of segments 704-708, respectively. As shown, the first segment, 704, is fluidly connected to the optional reservoir, 702, at one end and fluidically connected to a second segment, 705, at a second end of the segment. The temperature that the thermally active material, 703, begins to flow into channel segment 704 can depend on an interaction between the thermally active material and a functional group present within segment 704. In this embodiment, an interaction between the thermally active material, 703, and the channel segments, 704-708, is such that the threshold temperature at which the thermally active material flows into each segment of the channel increases incrementally from segment 704 to segment 708, respectively (i.e., the temperature at which the thermally active material flows into segment 704<705<706<707<segment 708). After a threshold temperature is reached such that flow of the thermally active material into a segment begins, a main portion of the segment becomes filled with the thermally active material. Extending from, and in fluid communication with, each segment of the channel are smaller capillary segments (indicated by “1,” “5,” “10,” “50,” “100,” “500” and “1000”). The capillary segments can include functional groups or be sized such that the duration of time required for each capillary to fill with the thermally active material is different. In some embodiments, after 1 minute at a temperature greater than the threshold temperature characteristic of the flow of thermally active material into segment 704, the capillary segment marked “1” fills with the thermally active material, after 5 minutes the capillary segment marked “5” fills with the thermally active material, after 10 minutes, the capillary segment marked “10” fills with the thermally active material, and so on. Thus, the duration that the system experiences a given temperature event (heat and duration) is indicated by the segments of the channel that become filled with the thermally active material and the number of various capillary channels within each segment that are also filled with the thermally active material.

In some embodiments, the characteristic temperature of one or more segments of the channel depends at least on the independent cross-sectional area of the segments of the channel. FIG. 8 provides a top-view schematic representation of a passive thermal monitoring system, 800, of the present invention. Referring to FIG. 8, the system, 800, comprises a matrix, 801, that includes an optional reservoir, 802, containing a thermally active material, 803. The optional reservoir is in fluid communication with a channel, 804, that has a negatively tapered cross-section and includes hashmarks indicative of temperature that are labeled “a,” “b,” “c” and “d;” and wherein temperature a<b<c<temperature d. The channel, 804, optionally includes at least one functional group. The flow of the thermally active material, 803, into channel 804, can depend on an interaction between the thermally active material and an optional functional group present within or on the channel and/or depend on the cross-sectional area of the channel. Thus, the thermally active material can progress into the channel only as the ambient temperature to which the system is exposed increases. In some embodiments, exposure of the system, 800, to a first temperature, a, induces the thermally active material to enter channel 804 and travel at least a distance to hashmark a. However, the thermally active material does not traverse a distance through the channel, 804, necessary to reach hashmark b until the system is exposed to a temperature b, wherein b>a.

Referring to FIG. 8, the system, 800, comprises side channels, 805, 806, 807 and 808, extending from, and in fluid communication with the channel, 804. In some embodiments, side channels 805-808 have a cross-sectional area that is less than that of channel 804. In some embodiments, the side channels 805-808 are fluidically isolated from one another. In some embodiments, the side channels, 805-808, each comprise functional groups on at least one surface of the segments, that can be the same or different to the functional groups attached to the surface of channel 804. The side channels comprise hashmarks (indicated by “5 min,” “30 min,” “1 h,” “6 h,” “12 h,” “1 day,” “7 days” and “14 days”), that indicate the duration the system is exposed to a temperature by the distance traversed by the thermally active material into the side channel. Any of the type, density, or pattern of functional groups, a cross-sectional dimension or area, or another characteristic of the side channel can determine the rate at which the thermally active material flows into each side channel. Thus, in some embodiments, when an ambient temperature, a, to which the system, 800, is exposed, the side channel, 805, begins to fill with the thermally active material such that after 5 minutes, the capillary segment marked “5 min” is filled with the thermally active material, after 30 minutes the capillary segment marked “30 min” will have filled with the thermally active material, after 1 hour, the capillary segment marked “1 h” will have filled with the thermally active material, and so on. Thus, the duration that the system experiences a given temperature event (heat and duration) is indicated by the extent to which the side channel is filled by the thermally active material. Moreover, each side channel, 805-808, corresponds to a different temperature. Thus, in some embodiments, the distance traversed in side channel 805 indicates the temporal duration at which the system, 800, was exposed to a temperature greater than or equal to temperature a; the distance traversed in side channel 806 indicates the temporal duration at which the system, 800, was exposed to a temperature greater than or equal to temperature b; and so on. In some embodiments, when the ambient temperature surrounding the system, 800, decreases below temperature a, then the thermally active material, 803, ceases to flow within side channel 805 (for example, the thermally active material can solidify, or lack the energy necessary to wet the inside of side channel 805). Thus, upon exposure of system, 800, to a temperature event, the extent to which any of side channels 805-808 is filled with a thermally active material provides both the temperature and duration to which system 800 was exposed.

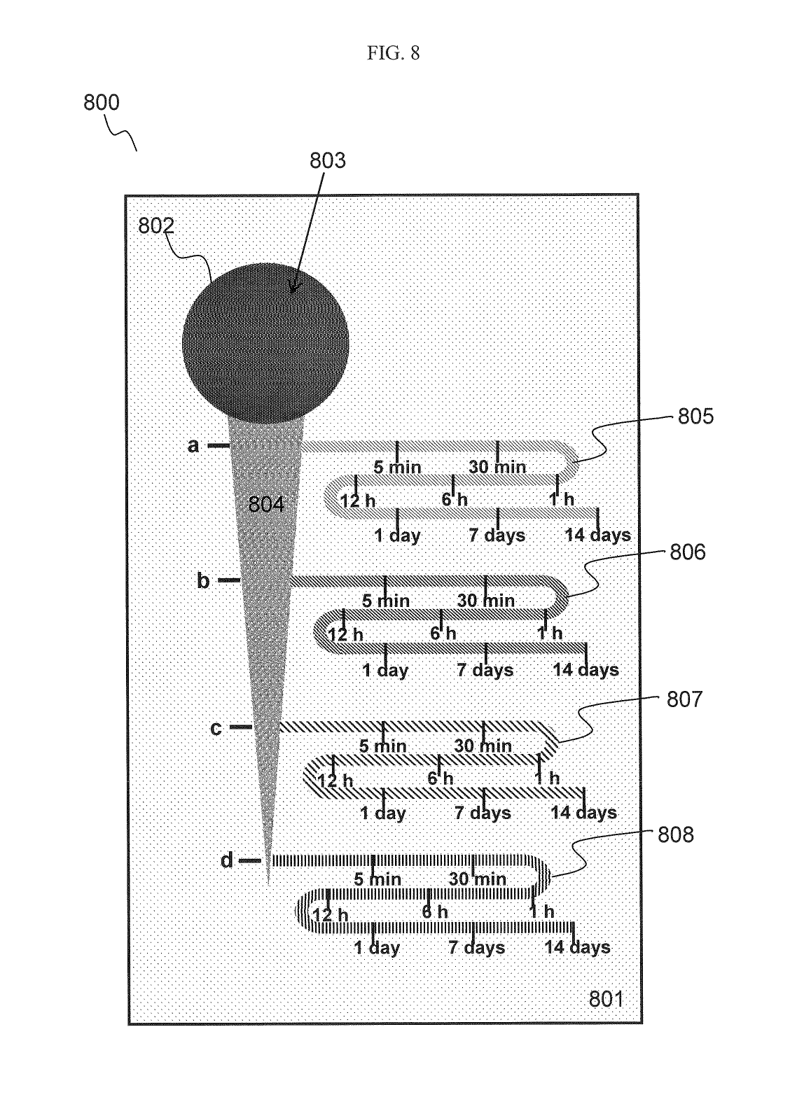

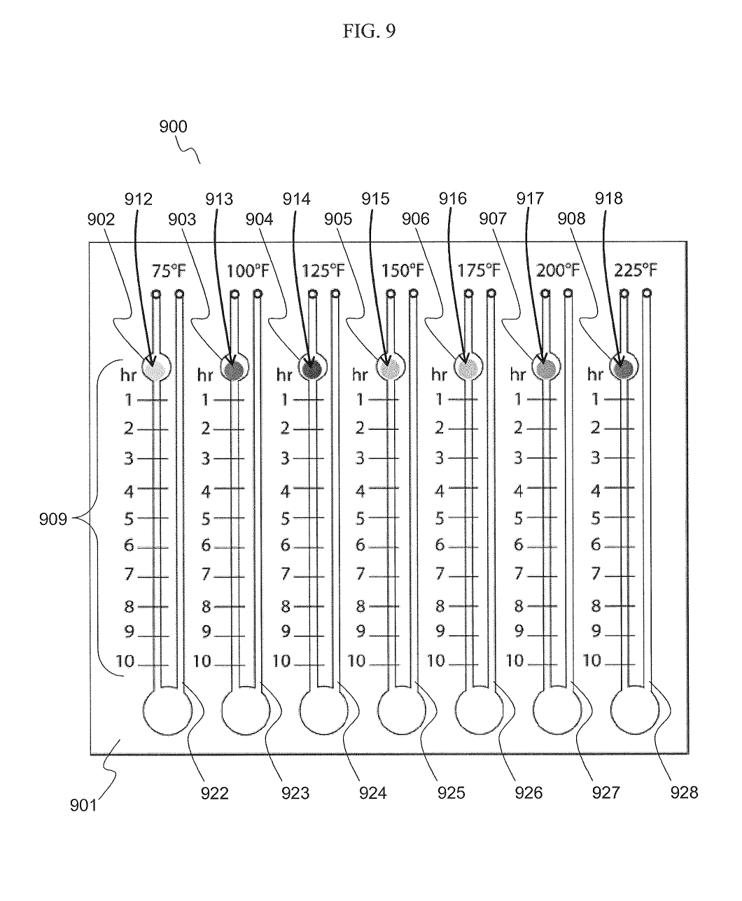

FIG. 9 provides a top-view schematic representation of a passive thermal monitoring system, 900, of the present invention. Referring to FIG. 9, the system, 900, comprises a matrix, 901, that includes reservoirs, 902, 903, 904, 905, 906, 907 and 908, which contain thermally active materials, 912, 913, 914, 915, 916, 917 and 918, respectively. The thermally active materials, 912-918, can be the same or different. The reservoirs, 802-808, are each fluidically connected to a channel, 922-928, respectively. In some embodiments, the channels, 922-928, are fluidically isolated from one another. In some embodiments, the channels, 922-928, comprise a vent suitable for maintaining an equilibrium pressure within the channel that is approximately equivalent to an ambient pressure. The channels, 922-928, can optionally include one or more functional groups on at least a portion of the channel surface, wherein the functional groups can be the same or different within a specific channel, or among two or more channels. The channels 922-928 each correspond to a temperature between 75° F. and 225° F., respectively, that is characteristic of the temperature at or above which a thermally active material present in a reservoir begins to flow into a channel to which the reservoir is fluidically connected. The channels comprise hashmarks 909 (i.e., “1” through “10”), which indicate the duration the system, 900, is exposed to a temperature that is associated with each channel, by the distance the thermally active material traverses inside each channel.

Referring to FIG. 9, upon exposure of the system, 900, to a thermal event, an interaction between the thermally active materials 912-918 and the channels 922-928, respectively, results in flow of a thermally active material (e.g., 912) into a channel (e.g., 922), when the system is exposed to a predetermined temperature (e.g., 25° C.). In some embodiments, the temperature at which a thermally active material begins to flow into a channel is predetermined by a melting point of the thermally active material. However, the predetermined rate at which a thermally active material flows into a channel to which a reservoir is fluidically connected can depend upon any of the type, density, or pattern of functional groups, a cross-sectional dimension or area, or another characteristic of the and an interaction between the thermally active material and a property of the channel. Thus, in some embodiments, when the system, 900, is exposed to an ambient temperature of 25° C., the channel, 922, begins to fill with the thermally active material, 912, such that after 1 hour, the thermally active material, 912, has flowed into the channel, 922, to the hashmark labeled “1;” after 2 hours, the thermally active material, 912, has flowed into the channel, 922, to the hashmark labeled “2;”, and so on. Thus, the duration that the system, 900, experiences a given temperature event (heat and duration) is indicated by the extent to which the side channel is filled by the thermally active material. Moreover, each channel, 902-908, corresponds to a different temperature. Thus, in some embodiments, the distance traversed in side channel 922 indicates the temporal duration at which the system, 900, was exposed to a temperature greater than or equal to 25° C.; the distance traversed in side channel 923 indicates the temporal duration at which the system, 900, was exposed to a temperature greater than or equal to 37° C.; and so on. In some embodiments, when the ambient temperature surrounding the system, 900, decreases below a temperature that is characteristic of a given channel/thermally active material combination, then the thermally active material ceases to flow within that channel (for example, the thermally active material can solidify, or lack the energy necessary to wet the inside of the channel). Thus, upon exposure of system, 900, to a temperature event, the extent to which any of the channels 922-928 are filled with a thermally active materials 912-918, respectively, provides the temperature history and duration from 25° C. to 125° C. to which system 900 was exposed.

Not being bound by any particular theory, a predetermined temperature at which a thermally active material begins to flow into a channel can correlate with the melting point of a thermally active material.

The present invention is also directed to a passive thermal monitoring system comprising a matrix including at least a first, a second, a third and a fourth channel therein, wherein the first, second, third and fourth channels have a cross-sectional area that is the same or different;

a first thermally active material having a melting point of −20° C. to 60° C., wherein the first thermally active material is positioned to be in fluid communication with at least the first channel in a fluid state, and wherein a rate of flow of the first thermally active material in a fluid state into and through at least the first channel occurs only above a threshold temperature that is 20° C. to 60° C.;

a second thermally active material having a melting point of 61° C. to 120° C., wherein the second thermally active material is positioned to be in fluid communication with at least the second channel in a fluid state, and wherein a rate of flow of the second thermally active material in a fluid state into and through at least the second channel occurs only above a threshold temperature that is 61° C. to 120° C.;

a third thermally active material having a melting point of 121° C. to 180° C., wherein the third thermally active material is positioned to be in fluid communication with at least the third channel in a fluid state, and wherein a rate of flow of the third thermally active material in a fluid state into and through at least the third channel occurs only above a threshold temperature that is 121° C. to 180° C.; and

a fourth thermally active material having a melting point of 181° C. to 250° C., wherein the fourth thermally active material is positioned to be in fluid communication with at least the fourth channel in a fluid state, and wherein a rate of flow of the fourth thermally active material in a fluid state into and through at least the fourth channel occurs only above a threshold temperature that is 181° C. to 250° C.

In some embodiments, the first channel comprises a first functional group, the second channel comprises a second functional group, the third channel comprises a third functional group, and the fourth channel comprises a fourth functional group; and wherein the first, second, third and fourth functional groups are independently the same or different.

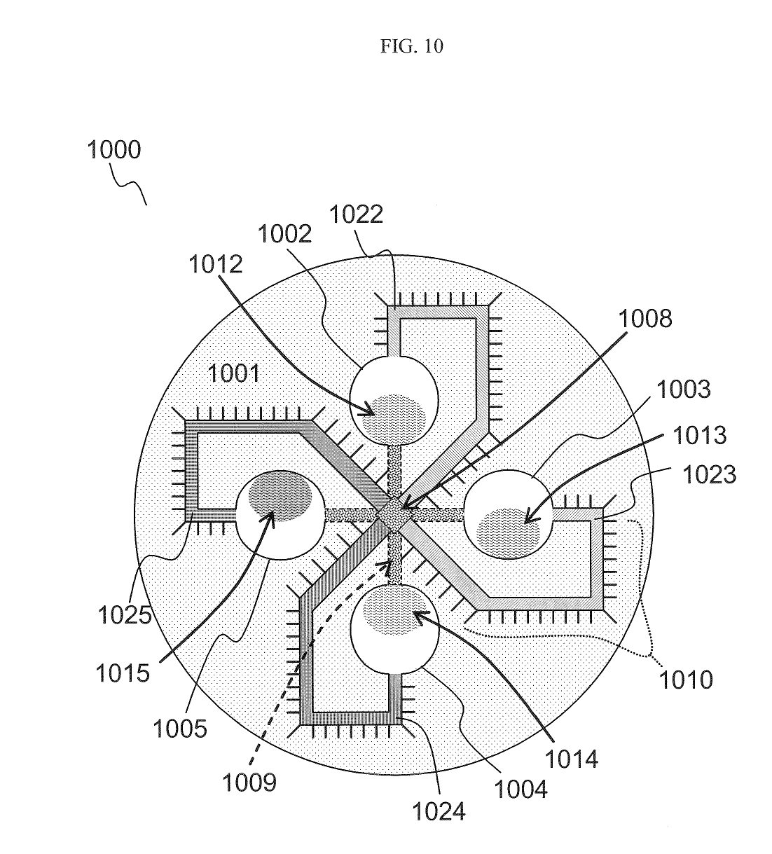

In some embodiments, a passive thermal monitoring system of the present invention comprises two or more thermally active materials. Thermally active materials can be contained within optional reservoirs that are in fluid communication with one or more channels. FIG. 10 provides a top-view schematic representation of a passive thermal monitoring system, 1000, of the present invention. Referring to FIG. 10, the system, 1000, comprises a matrix, 1001, that includes optional reservoirs, 1002, 1003, 1004 and 1005, which contain thermally active materials, 1012, 1013, 1014 and 1015, respectively. The thermally active materials, 1012-1015, can be the same or different. The optional reservoirs, 1002-1005, are each fluidically connected to a channel, 1022-1025, respectively, which are also gaseously connected to one another, 1008. The channels, 1022-1025, can optionally include one or more functional groups on and/or in at least a portion of the channel, wherein the functional groups can be the same or different within a specific channel, or among two or more channels. The channels 1022-1025 each have a different characteristic temperature in the range of −20° C. to 250° C., respectively, that is characteristic of the temperature at or above which a thermally active material present in a reservoir begins to flow into a channel to which the reservoir is fluidically connected. The channels comprise hashmarks 1010, which indicate the duration the system, 1000, is exposed to a temperature that is associated with each channel, by the distance the thermally active material traverses inside each channel.

The passive thermal monitoring system of FIG. 10 operates in a manner similar to that described herein for other systems of the present invention. In some embodiments, the gaseous connection, 1009, comprises a material through which a gas present within the system can traverse, but through which thermally active materials, 1012-1015, cannot pass. In some embodiments, the gaseous connection, 1009, that links channels 1022, 1023, 1024 and 1025 to each other enables the system to operate without the need for a vent that can maintain an equilibrium pressure within the system. In some embodiments, the system comprises optional gaseous connections, 1009, capable of placing one or more of the reservoirs, 1002-1005, in gaseous communication with one or more of the channels, 1012-1015.

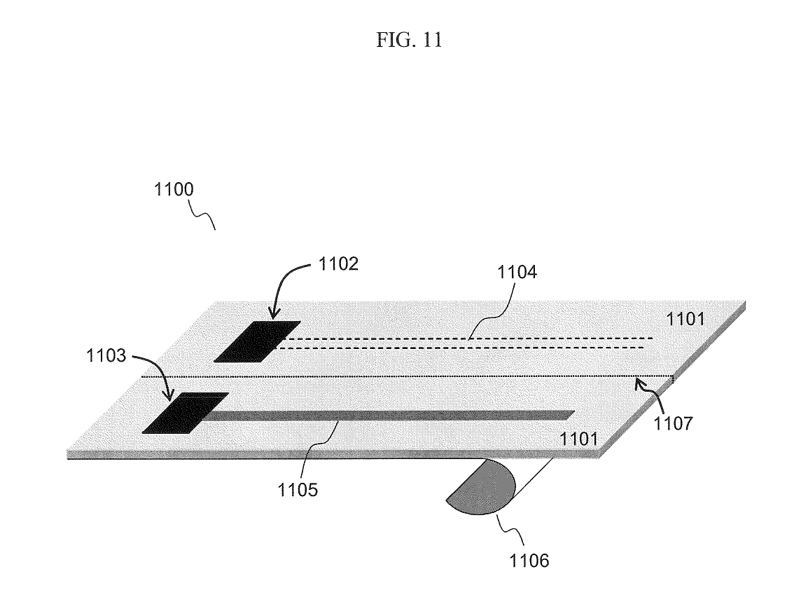

FIG. 11 provides a three-dimensional schematic representation, 1100, of a passive thermal monitoring system of the present invention. Referring to FIG. 11, the passive thermal monitoring system comprises a matrix, 1101, and thermally active materials 1102 and 1103 that are fluidically connected to channels, 1104 and 1105, respectively. The matrix, 1101, is a thin, flexible material (e.g., paper, a polymer sheet, and the like) on and/or in which a thermally active material is applied and contained. In some embodiments, a channel, 1104, is a spatially defined section of the matrix, 1101, and the matrix material present in the channel can function as a wick for the thermally active material. Spatial definition of a channel, 1104, can be performed, for example, by laser cutting, perforation, mechanical compression, and the like, and combinations thereof. A channel, 1105, can also be spatially defined by, for example, by chemical functionalization of a portion of the matrix that comprises the channel.

Further referring to FIG. 11, the passive thermal monitoring systems of the present invention can be packaged together as sheets, rolls, and the like, separated by, e.g., a perforation, 1107. In some embodiments, the passive thermal monitoring systems comprise a peelable backing layer, 1106, that covers, for example, an adhesive.

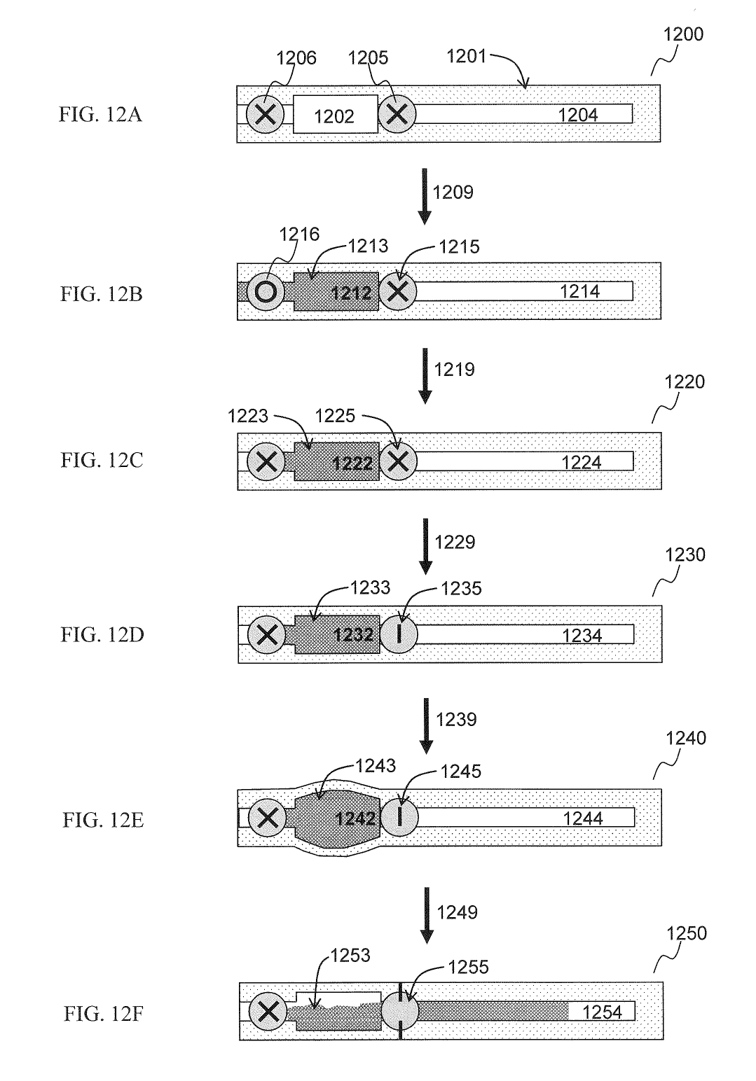

FIG. 12A provides a side-view schematic representation of a passive thermal monitoring system, 1200, of the present invention. Referring to FIG. 12A, system, 1200, comprises a matrix, 1201, that encloses a reservoir, 1202, which is fluidically connected to at least one channel, 1204. Suitable materials for the matrix include those described herein. The system comprises an optional first valve, 1205, and an optional second valve, 1206. In some embodiments, the optional first valve is a pressure-sensitive membrane-type valve that can be set, and later rupture at a predetermined applied pressure. In some embodiments, the optional first valve is a removable blocker, a resealable opening, and the like that can reversibly prevent the reservoir, 1202, from being in fluid communication with the at least one channel, 1204.

FIGS. 12B-12C provide a cross-sectional schematic representation of the operation of the system described in FIG. 12A. Referring to FIG. 12A, the optional first valve, 1205, is closed, sealed, blocked so that the reservoir, 1202, can be filled, 1209, with a thermally active material such that the thermally active material fills the reservoir without flowing into the at least one channel, 1204.

Referring to FIG. 12B, optional second valve, 1216, is open, and the reservoir, 1212, is filled with a thermally active material, 1213. The thermally active material, 1213, can be added without the use of optional valve, 1216, for example, using a syringe, tube, capillary action, and the like. The thermally active material can be added to the reservoir in the liquid and/or solid state. If added to the reservoir in the liquid state, in some preferable embodiments, the temperature is maintained as close as possible to a melting point of the thermally active material during the adding. During the filling, the optional first valve, 1215, remains in an inactive position so that the thermally active material, 1213, does not flow into channel 1214. As discussed above, the optional first valve can alternatively comprise (instead of a valve) any material capable of being removed after the reservoir is filled. After the reservoir, 1212, is completely filled with the thermally active material, 1213, the reservoir is sealed, 1219. In some embodiments, sealing comprises placing the optional second valve, 1216, in a closed position. Sealing can also be achieved by, e.g., annealing the system, pinching an edge of the system, applying an adhesive or filler to an outside surface of the system, and the like. The thermally active material, 1213, is of a type that undergoes thermal expansion when heated to a temperature greater than its melting point. Suitable thermally active materials that undergo thermal expansion are provided herein, and also include thermally expansive materials known to persons of ordinary skill in the art.

Referring to FIG. 12C, the system, 1220, comprises a reservoir, 1222, filled with a thermally active material, 1223, wherein the system is inactive, and ready for use. When an item in need of thermal monitoring is identified, the system, 1220, is activated, 1229. In general, activation includes any process whereby the filled reservoir is placed in fluid communication, or potential fluid communication, with the at least one channel, 1224. In some embodiments, the optional first valve, 1225, comprises a material that can be selectively removed without disturbing the thermally active material, 1223, such that upon reaching a critical temperature the thermally active material, 1223, flows into the at least one channel, 1224. In some embodiments, the optional first valve, 1225, comprises a pressure sensitive valve that is placed in a position such that the valve can be ruptured by an applied force, such as a pressure.

Referring to FIG. 12D, the activated system, 1230, comprises a matrix, 1231, that encloses a reservoir, 1232, which is entirely filled with a thermally active material, 1233. The reservoir is fluidically connected to a channel, 1234, by an optional first valve, 1235, which has been placed in a position such that the thermally active material can flow into the at least one channel. In some embodiments, the optional first valve, 1235, comprises a pressure sensitive membrane that has been activated. The activated system, 1230, is then placed in an environment in which the activated system, 1230, is exposed to a thermal event, 1239.

Referring to FIG. 12E, the activated system, 1240, is exposed to a temperature greater than the melting point of thermally active material, 1243, and the thermally active material expands. The expansion of the thermally active material increases the internal pressure of the reservoir, 1242. While FIG. 12E depicts the sidewalls, 1247, of the reservoir expanding, this is for purposes of illustration only, and the system and/or matrix and/or reservoir need not undergo deformation during active use of the system. The optional first valve, 1245, forms a fluid pathway for the thermally active material to flow into the at least one channel, 1244. Thus, when the thermally active material, 1243, reaches a critical temperature, or the internal pressure of the reservoir, 1242, is equal to or greater the potential energy barrier for the thermally active material to enter the at least one channel, the thermally active material flows, 1249, into channel 1244. In some embodiments, the optional first valve, 1245, comprises a pressure sensitive valve that is set to rupture at a predetermined applied pressure. Thus, when the internal pressure of the reservoir, 1242, is equal to or greater than a rupture pressure of a pressure sensitive valve, the valve ruptures, and the thermally active material flows, 1249, into channel 1244.

Not being bound by any particular theory, the reservoir containing the thermally active material is a store of potential energy. In embodiments in which the optional first valve is an opening, when a critical amount of potential energy is obtained that provides an applied force greater than the energy barrier between the reservoir and the at least one channel, then the potential energy is converted into kinetic energy, and the thermally active material flows into the channel to which the reservoir is fluidically connected. In embodiments in which the optional first valve is a pressure sensitive valve, when a critical amount of potential energy is obtained that provides an applied force greater than the cohesive force of a membrane within the pressure-sensitive valve, then the potential energy is converted into kinetic energy, and the thermally active material flows into the channel to which the reservoir is fluidically connected.

Referring to FIG. 12F, the system, 1250, was exposed to a thermal event that included a temperature greater than a predetermined temperature corresponding to a potential energy necessary for the thermally active material, 1253, to flow into the at least one channel, 1254. In some embodiments, the system, 1250, can be exposed to a thermal event that included a temperature greater than a predetermined temperature corresponding to a potential energy necessary to rupture a pressure-sensitive valve, and the thermally active material, 1253, flows into channel 1254, as a result of the force generated by the thermally active material being greater than the rupture strength of the valve. Because the thermally active material can have a known melting point and known rheological properties, the precise temperature at which the thermally active material flows into the at least one channel can be well understood. For example, in some embodiments, the thermally active material undergoes thermal expansion in a predictable manner, and the reservoir and optional first valve can be selected to induce rupture of the valve at a predetermined temperature.

Referring to FIG. 12F, in some embodiments, the distance the thermally active material traverses within the channel, 1254, can indicate the maximum temperature to which the system, 1250, was exposed.

Also included within the scope of the present invention is a system comprising multiple reservoirs and/or multiple different thermally active materials and/or multiple different pressure sensitive valves such that a single passive thermal monitoring system can record the temperature history of a thermal event. Variables that can be modified to change a predetermined temperature at which a valve or membrane of a system of the present invention ruptures, include, but are not limited to, the type (i.e., chemical composition) of a material selected for use as a membrane or valve, the surface area of the valve membrane, the thickness of the valve membrane, the type (i.e., chemical composition) of a thermally active material, the amount of a thermally active material placed in the reservoir, the volume of the reservoir, the rigidity/flexibility of the reservoir surface (which can be at least a portion of the matrix, a backing layer, a top layer, and combinations thereof), and combinations thereof.

The present invention is also directed to a passive thermal monitoring system comprising a magnetic material having a Curie temperature, the magnetic material having a known magnetic moment at a baseline temperature that is less than the Curie temperature, wherein exposure of the passive thermal monitoring system to a temperature greater than the baseline temperature provides an incremental decrease in the magnetic moment of the magnetic material such that the decrease in the magnetic moment after a period of use correlates with a maximum temperature to which the passive thermal monitoring system is exposed during the period of use.

The present invention is also directed to a passive thermal monitoring system comprising two or more magnetic materials having an attractive interaction, wherein the magnetic materials are affixed to a three-dimensional support, at least a portion of which is flexible

As used herein, the team “magnetic materials” includes magnetic, paramagnetic, superparamagnetic, ferromagnetic, and ferrimagnetic materials. In some embodiments, the magnetic materials are ferromagnetic or ferrimagnetic. The magnetic material can also be formed from a combination of magnetic and non-magnetic materials. In some embodiments, the magnetic material has a Curie temperature of −100° C. to 1200° C., −75° C. to 300° C., −50° C. to 150° C., or −25° C. to 100° C.

A magnetic material suitable for use with the present invention can include a plurality of particles, a monolithic material, a ferroliquid, and the like, and combinations thereof.

Magnetic particles for use with the present invention are not particularly limited by shape, and can include any three-dimensional shape. In some embodiments, the magnetic particles have a cross-sectional dimension (e.g., diameter) of 5 nm to 1 mm, 50 nm to 500 μm, 100 nm to 100 μm, 200 nm to 50 μm, or 500 nm to 20 μm.

Magnetic materials suitable for use in the particles include, but are not limited to, Co, Fe, Gd, Dy, Ni, CrO₂, EuO, Y₃Fe₅O₁₂, FeO/Fe₂O₃, NiO/Fe₂O₃, MgO/Fe₂O₃, MnO/Fe₂O₃, MnBi, MnSb, MnAs, CuNi, SmCO₅, Sm(Co,Fe, Cu,Zr)₇, MnGdFe, ZnGdFe, GdFeB, NdFeB (e.g., sintered or bonded Nd₂Fe₁₄B), MnZnGdFe, and the like, and combinations thereof.

Magnetic particles can be synthesized using chemical and/or physical methods. For example, magnetic particles can be prepared by co-precipitation methods, a chemical reduction (e.g., borohydride reduction), a chemical oxidation, and the like.

In some embodiments, magnetic particles are encapsulated in and/or coated with one or more materials such as, but not limited to, an oligomer, a polymer, a resin, an epoxy, an oxide, a nitride, a carbide, an oxynitride, an oxycarbide, and the like, and combinations thereof.

A magnetic material is oriented in a three-dimensional arrangement such that the magnetic moment of the material can be readily determined. For example, a channel comprising a magnetic material can be surrounded by a conductive material to provide an induction coil. In some embodiments, a passive thermal monitoring system comprises a plurality of channels, each channel comprising a magnetic material having a different Curie temperature, such that a change in magnetic moment for each channel as a function of temperature is different. In this manner, a passive thermal monitoring system that is suitable for detecting and responding to a wide range of temperatures is provided, wherein each channel within the sensor device undergoes a separate response to temperature change.

The present invention is also directed to a method for preparing a passive thermal monitoring system comprising a magnetic material, the method comprising heating the magnetic material to a temperature above the Curie temperature of the magnetic material; applying an external magnetic field to the magnetic material; and cooling the magnetic material to a temperature below the Curie temperature while applying the external magnetic field.

After use, a passive thermal monitoring system comprising a magnetic material can be re-activated or re-set for use using the above process of heating the magnetic material to a temperature above the Curie temperature; applying an external magnetic field to the magnetic material; and cooling the magnetic material to a temperature below the Curie temperature while applying the external magnetic field.

The present invention is also directed to integrated circuits comprising the passive magnetic material thermal monitoring systems. For example, an integrated chip comprising an electrical conductor formed as a coil around a channel filled with magnetic particles, a monolithic magnetic material, and/or a ferroliquid.

The present invention is also directed to a passive thermal monitoring system comprising a three-dimensional substrate, at least a portion of which is flexible; a first magnetic material affixed on or in a first area of the substrate; and a second magnetic material on or in a second area of the substrate, wherein the first and second magnetic materials are attracted to one another by a magnetic force at a baseline temperature less than the Curie temperature of either material, wherein the three-dimensional substrate is mechanically configured to store potential energy in opposition to the attractive magnetic force between the first and second materials, wherein at a baseline temperature less than the Curie temperature of either material the stored potential energy is less than the magnetic attractive force between the first and second materials, and wherein at a temperature above the baseline temperature the attractive force between the first and second magnetic materials decreases such that the attractive force is less than the potential energy, and the potential energy is released as a mechanical reconfiguration of the three-dimensional substrate.

The present invention is also directed to a passive thermal monitoring system comprising first and second mechanical elements, a first magnetic material affixed on or in the first mechanical element; and a second magnetic material on or in a second mechanical element, wherein the first and second magnetic materials are attracted to one another by a magnetic force at a baseline temperature less than the Curie temperature of either magnetic material, wherein the first and second mechanical elements are configured to store potential energy in opposition to the attractive magnetic force between the first and second materials, wherein at a baseline temperature less than the Curie temperature of either magnetic material the stored potential energy is less than the magnetic attractive force between the first and second magnetic materials, and wherein at a temperature above the baseline temperature the attractive force between the first and second magnetic materials decreases such that the attractive force is less than the potential energy, and the potential energy is released as a mechanical reconfiguration of at least one of the first or second mechanical elements.

In some embodiments, the first and second mechanical elements are selected from: a substrate, a cantilever, a micromirror, a hinge, a deflector, a microfluidic valve, and combinations thereof. Thus, upon heating to a predetermined temperature at least the first and/or second mechanical element reconfigures by mechanical motion, for example, a change in the angle of a cantilever, a change in position of a micromirror, a change in angle of a deflector, a change in position (e.g., opening) of a microfluidic valve, and the like. Additional exemplary mechanical reconfigurations within the scope of the present invention include a removal of a portion of the substrate from an optical path to increase transparency, removal of a portion of the substrate to provide/reveal a colored surface, and the like.

The present invention is also directed to a passive thermal monitoring system comprising parallel conductive surfaces having a variable distance and a thermally sensitive material there between, wherein the thermally sensitive material has a coefficient of linear thermal expansion at 20° C. of at least 10 ppm/° C., and wherein linear change of the thermally sensitive material results in a change in capacitance between the parallel conductive surfaces.

When electrically connected to an integrated circuit, or another memory device, the thermal history of an object to which a passive thermal monitoring system is affixed can be recorded by a change in capacitance over time.

The present invention is also directed to a passive thermal monitoring system comprising a reflective element and a thermally sensitive material having a coefficient of linear thermal expansion at 20° C. of at least 10 ppm/° C., wherein linear change of the thermally sensitive material modifies at least one of: the intensity of light or the angle of light reflected from the reflective element.

In some embodiments, the passive thermal monitoring system comprises a light source, wherein the reflective element is a minor, and linear expansion of the material modifies at least the angle of light reflected from the reflective element.

In some embodiments, a thermally sensitive material has a coefficient of linear thermal expansion at 20° C. of at least 10 ppm/° C., at least 20 ppm/° C., at least 30 ppm/° C., at least 40 ppm/° C., at least 50 ppm/° C., at least 60 ppm/° C. Suitable materials include, but are not limited to, metals (e.g., nickel, gold, copper, steel, silver, brass, aluminum, magnesium, lead, and the like), plastics (e.g., polyvinylchloride, PDMS, rubber, and the like), liquids (e.g., water, ethanol, mercury, and the like), solids (e.g., concrete, and the like), and combinations thereof. In some embodiments, a thermally sensitive material is an elastomer. Elastomers suitable for use as thermally sensitive materials with the present invention include those elastomers described elsewhere herein.

In some embodiments, a dielectric material can be located in a sealed, expandable compartment comprising parallel plates, wherein the compartment is pressurized, at atmospheric pressure, or at sub-atmospheric pressure.

The present invention is also directed to a passive thermal monitoring system comprising at least a first thermally sensitive material in a solid state, wherein exposure of at least the first thermally sensitive material to a temperature greater than at least one of: a phase transition temperature of the first thermally sensitive material, a melting point of the first thermally sensitive material, or a softening temperature of the first thermally sensitive material provides an observable change in the passive thermal monitoring system.

Observable changes include, but are not limited to, a change in capacitance, a change in conductivity, a change in signal frequency, a change in density, a change in opacity (transparency), a color change, a change in three-dimensional (physical) shape, and the like, and combinations thereof.

Thus, the present invention includes a passive thermal monitoring system comprising two conductive surfaces separated by at least the first thermally sensitive material in a solid state, wherein exposure of the first thermally sensitive material to a temperature greater than at least one of: a phase transition temperature of the first thermally sensitive material, a melting point of the first thermally sensitive material, or a softening temperature of the first thermally sensitive material provides a change in the conductivity between the two conductive surfaces.

In some embodiments, the passive thermal monitoring system comprises a second thermally sensitive material in a solid state, wherein exposure of the first and second thermally sensitive materials to a temperature greater than the melting points of the first and second thermally sensitive materials provides a mixing of the first and second thermally sensitive materials. Mixing of two or more thermally sensitive materials can result in a chemical reaction, a color change, a change in three-dimensional shape, and the like.

Thus, the present invention is directed to a passive thermal monitoring system comprising first and/or second thermally sensitive materials comprising a colorant, wherein mixing of the first and second thermally sensitive materials results in a color change, and wherein the color change correlates with a maximum temperature to which the passive thermal monitoring is exposed.

In some embodiments, mixing occurs at a temperature above a predetermined temperature, and a chemical reaction only occurs if the temperature is maintained for a predetermined period of time.

In some embodiments, a passive thermal monitoring system of the present invention comprises an electrical component such as, but not limited to, a light emitting diode, an electrode, a capacitor, an inductor, an integrated circuit, a digital readout, and the like, and combinations thereof. In some embodiments, a passive thermal monitoring system includes a means for forming an electrical connection between one or more electrical components within a microfluidic system as disclosed, for example, in PCT Pub. No. WO 2007/061448, which is hereby incorporated by reference in its entirety.

### Methods

The present invention is also directed to methods of using the passive thermal monitoring systems described herein to passively monitor the temperature history of an item, object, package, container, shipment, cargo, vessel, and the like.

Non-limiting items, objects and/or articles to which the passive thermal monitoring systems of the present invention can be affixed include ordinance (e.g., explosives, high explosives, bombs, missiles, rockets, grenades, bullets, and the like); electronic devices (e.g., data storage devices, radar, displays, circuits, and the like); bearings; transportation (automobiles, trains, marine vessels, aerospace, and components thereof); analytical equipment (e.g., pumps, filters, and components thereof); food (e.g., perishables, dairy products, frozen consumables, and the like); pharmaceuticals (e.g., active ingredients, pills, tablets, solutions, and the like); photovoltaic cells; biological material (e.g., organs, blood, tissue, and the like); energy storage receptacles (e.g., batteries, fuel cells, fuel tanks, and the like); antennas; artwork (e.g., paintings, sculptures, tapestries, and the like); jewelry; containers therefor; and combinations thereof, or any other item in need of thermal monitoring to which a person of ordinary skill in the art would affix a passive thermal monitoring system. In particular, the passive thermal monitoring systems of the present invention are useful for protecting and indicating the temperature history of high-value components present in engines, pumps, and the like in order to prevent catastrophic failure.

In some embodiments, the present invention includes methods of applying the passive thermal monitoring systems to an article. In some embodiments, a method comprises optionally cleaning a surface of an article, peeling an optional protective layer from a surface of the passive thermal monitoring system, and affixing the passive thermal monitoring system to the article. In some embodiments, the system is affixed conformally to a curved surface of an article.

In some embodiments, the system comprises a protective coating on a front surface. The front coating is dirt resistant, cleanable, self-cleanable, peelable, and the like. In some embodiments, a front surface of a system comprises a plurality of optically clear peelable layers that can be removed periodically for viewing the status of the passive thermal monitoring system after it is applied to an object.

The present invention is also directed to methods for preparing the passive thermal monitoring systems. The fluidic devices comprising three-dimensional channel structures (e.g., polymeric microfluidic network structures having a three-dimensional array of channels included therein) can be fabricated by a variety of methods.

The methods of the present invention generally comprise: foil ring one or more channels in a matrix; and forming one or more reservoirs in a matrix. The present invention is also directed to methods of forming the passive thermal monitoring systems described herein. For example, in some embodiments a matrix having a plurality of channels and one or more reservoirs therein, and a backing layer are provided, a thermally active material is applied to at least the reservoir present in the matrix, the matrix and the backing layer are aligned with respect to each other, and the matrix and the backing layer are contacted with one another, thereby sealing the surfaces together via a chemical reaction between the surfaces.

In some embodiments, one or more channels and/or one or more reservoirs are formed in a matrix via conventional photolithography, microassembly, or micromachining methods, for example, stereolithography methods, laser chemical three-dimensional writing methods, a die cutting method, and/or modular assembly methods. In some embodiments, the systems of the present invention are fabricated by a process that involves replica molding to produce individual layers having various functional groups and/or features on their surface(s). In some embodiments, features formed via a photolithography method can themselves comprise a molded replica of such a surface. In some embodiments, the structures of the present invention are injection molded or cast molded.

In some embodiments, a method comprises providing at least one mold substrate, forming at least one topological feature on a surface of the mold substrate to form a mold master, contacting the first mold master with a matrix precursor, hardening the matrix precursor to form a matrix that includes one or more reservoirs and one or more channels therein corresponding to the topological features of the mold master wherein the reservoir(s) and channel(s) are partially enclosed on three side by the matrix, removing the matrix from the mold master, contacting a side of the matrix having openings to the reservoir(s) and channel(s) with a backing layer to fully enclose the reservoir(s) and channel(s).

In some embodiments, a method comprises providing at least one mold substrate, forming at least one topological feature on a surface of the mold substrate to form a mold master, contacting the first mold master with a matrix precursor, hardening the matrix precursor to form a matrix that includes one or more reservoirs and one or more channels therein corresponding to the topological features of the mold master, removing the matrix from the mold master, contacting a first side of the matrix with a backing layer to partially enclose the reservoir(s) and channel(s), and contacting a second side of the matrix with a top layer to fully enclose the reservoir(s) and channel(s).

A thermally active material can be deposited or injected into the reservoir(s) before or after the reservoir(s) are fully enclosed within the system. For example, a thermally active material can be placed in the reservoir(s) before or after the contacting a second side of the matrix by, for example, vapor deposition, syringe deposition, injection (e.g., syringe injection, and the like), permeation (e.g., through any one of the top layer, backing layer, and/or matrix), and combinations thereof.

The thermally active material deposition and/or injection is performed under conditions sufficient to deposit the thermally active material in the reservoir. In some embodiments, the thermally active material is maintained in a liquid, viscous, semi-viscous, or otherwise flowable state during the depositing. In some embodiments, maintaining the thermally active material in a liquid, viscous, semi-viscous, or otherwise flowable state can be done by dissolving or suspending the thermally active material in a solvent. However, it will be generally desirable to remove a solvent from a thermally active material prior to enclosing the thermally active material in the system of the present invention. A solvent-less method suitable for maintaining the thermally active material in a liquid, viscous, semi-viscous, or otherwise flowable state, and to facilitate transfer of the thermally active material into the reservoir is by applying thermal energy to any of: a vessel containing the thermally active material, the thermally active material, the matrix, the backing layer, and combinations thereof.

In some embodiments, the methods of the present invention comprise annealing the system or a portion of the system prior to the addition of a thermally active material. As used herein, “annealing” refers to applying thermal energy to, removing a solvent from, and/or chemically treating a matrix, backing layer, channel, and/or reservoir, or a portion thereof.

In some embodiments, a method comprises exposing portions of a surface of a first layer of photoresist to radiation in a first pattern, coating the surface of the first layer of photoresist with a second layer of photoresist, exposing portions of a surface of the second layer of photoresist to radiation in a second pattern different from the first pattern, and developing the first and second photoresist layers with a developing agent. The developing step yields a positive relief pattern in photoresist that includes at least one two-level topological feature. The two-level topological feature is characterized by a first portion having a first height with respect to the surface of the material and a second portion, integrally connected to the first portion, having a second height with respect to the surface of the material. The two-level topological feature can be used as a mold master suitable for forming a matrix having one or more reservoirs and one or more channels therein.

In some embodiments, a method comprises providing a first mold master having a surface formed of an elastomeric material and including at least one topological feature thereon, providing a second mold master having a surface including at least one topological feature thereon, placing a matrix precursor in contact with the surface of at least one of the first and second mold master(s), bringing the surface of the first mold master into at least partial contact with the surface of the second mold master, and hardening the matrix precursor to create a reservoir(s) and channel(s) having three-dimensional shape(s) characteristic of the molded replica of the surface of the first mold master and the surface of the second mold master, and removing the molded replica from at least one of the mold masters.

In some embodiments, a method comprises providing a first mold master having a surface including at least a first topological feature thereon and at least a second topological feature comprising a first alignment element; providing a second mold master having a surface including at least a first topological feature thereon and at least a second topological feature comprising a second alignment element having a shape that is mate-able to the shape of the first alignment element; placing a matrix precursor in contact with the surface of at least one of the first and second mold master; bringing the surface of the first mold master into at least partial contact with the surface of the second mold master; aligning the first topological features of the first and second mold masters with respect to each other by adjusting a position of the first mold master with respect to a position of the second mold master until the first alignment element matingly engages and/or interdigitates with the second alignment element; hardening the matrix precursor to provide a matrix comprising one or more reservoirs and one or more channels that is a molded replica of the surface of the first mold master and the surface of the second mold master; and removing the molded matrix from at least one of the mold masters.

In some embodiments, a method comprises providing a first mold master having a surface with a first set of surface properties and providing a second mold master having a surface with a second set of surface properties, wherein the first and second mold masters has a surface including at least one topological feature thereon; placing a matrix precursor in contact with the surface of at least one of the first and second mold masters; bringing the surface of the first mold master into at least partial contact with the surface of the second mold master; hardening the matrix precursor thereby creating a matrix having one or more reservoirs and one or more channels therein that are a topological replica of the surface of the first mold master and the surface of the second mold master; separating the mold masters from each other; and removing the matrix from the surface of the first mold master while leaving the matrix in contact with and supported by the surface of the second mold master.

The methods of foaming a reservoir and a channel in a matrix can provide one or more reservoirs and one or more channels that are fluidically connected to one another immediately after the forming, or an additional fluidically connecting step can be performed to fluidically connect the reservoir(s) and channel(s) to each another after the forming and/or after providing a thermally active material in the at least the one or more reservoirs. For example, a portion of the matrix can be removed by etching, cutting, milling, dissolving, grinding, and the like to fluidically connect the one or more reservoirs and one or more channels to each another.

In some embodiments, at least a portion of a surface of a channel and/or a surface of a reservoir can be selectively patterned, functionalized, derivatized, textured, or otherwise pre-treated. As used herein, “pre-treating” refers to chemically or physically modifying a surface. Pre-treating can include, but is not limited to, cleaning, oxidizing, reducing, derivatizing, functionalizing, as well as exposing a substrate to any one of: a reactive gas, an oxidizing plasma, a reducing plasma, a thermal energy, an ultraviolet radiation, a visible radiation, an infrared radiation, and combinations thereof.

For example, at least a portion of a surface of a channel and/or a surface of a reservoir can be pre-treated by applying a self-assembled monolayer (“SAM”) pattern to at least a portion of the surface of the channel. A SAM-forming species can be transferred from, e.g., a stamp to a channel surface to form a pattern comprising at least one of a thin film, a monolayer, a bilayer, and combinations thereof on the channel surface. In some embodiments the SAM-forming species can react with the channel surface (e.g., a surface of a matrix and/or a surface of a backing or top layer). A thermally active material can then be applied to the reservoir, and its movement from the reservoir will depend on a surface interaction with the SAM that is formed on the channel surface.

Not being bound by any particular theory, pre-treating at least a portion of a surface of a channel can increase or decrease an adhesive interaction between a thermally active material and a surface of a channel. For example, derivatizing a channel surface with a polar and/or hydrophilic functional group can promote wetting of the channel by a hydrophilic thermally active material. In some embodiments, pre-treating a surface of a channel can prevent a thermally active material from penetrating into a matrix. Alternatively, derivatizing a channel surface with a polar functional group (e.g., oxidizing a surface of a channel) can diminish the wetting of a channel by a hydrophobic thermally active material and deter surface wetting by a hydrophobic thermoplastic polymer. In some embodiments, pre-treating a surface of a channel and/or reservoir can ensure uniform wetting of a channel surface, and facilitate the consistent performance of the systems.

In some embodiments, at least a portion of a surface of a channels and/or at least a portion of a surface of a reservoir can be functionalized or derivatized using a patterning method selected from: microcontact printing, micro transfer molding, micromolding in capillaries, chemical vapor deposition, thermal deposition, plasma enhanced chemical vapor deposition, and combinations thereof. The functionalization and/or derivitization can introduce one or more functional groups, as described herein, onto at least a portion of a surface of a reservoir and/or channel to control the surface free energy, hydrophobicity, hydrophilicity, density, chemical resistance, thermal resistance, and the like, and combinations thereof, of the surface.

In some embodiments, the methods of the present invention comprise patterning at least a portion of a surface of the one or more channels and/or at least a portion of the one or more matrixes with a functional group as described herein.

In some embodiments, a method comprises functionalizing, derivatizing and/or pre-treating at least a portion of the a surface of a matrix prior to the joining the matrix to a backing layer. In some embodiments, a backing layer and/or a top layer can be patterned prior to or after affixing to a matrix. In some embodiments, pre-treating the substrate comprises depositing a contact layer a backing layer and/or top layer. As used herein, a “contact layer” refers to a thin film, self-assembled monolayer, and the like, and combinations thereof capable of increasing an adhesive force between a matrix and a backing and/or top layer, increasing an adhesive or a repulsive force between a channel and/or reservoir surface and a thermally active material, and combinations thereof. In some embodiments, the depositing a contact layer comprises depositing a self-assembled monolayer.

An adhesive can be applied to a matrix and/or a layer suitable for applying to a surface of the matrix by a coating method known in the art such as, but not limited to, screen printing, ink jet printing, syringe deposition, spraying, spin-coating, brushing, atomizing, dipping, aerosol depositing, capillary wicking, and combinations thereof.

The matrix can be contacted with a backing layer and/or a top layer for an amount of time and/or under conditions sufficient to join the matrix to the backing layer and/or the top layer. Not being bound by any particular theory, adhesion of a backing and/or top layer to a matrix surface can be promoted by gravity, a Van der Waals interaction, a covalent bond, an ionic interaction, a hydrogen bond, a hydrophilic interaction, a hydrophobic interaction, a magnetic interaction, and combinations thereof.

### EXAMPLES

### Comparative Example 1

An open-ended glass capillary (having a interior diameter of approximately 1 mm) was packed at one end with a thermally active material (approximately 5 mg of dry palmitic acid powder).

The open-ended glass capillary was placed on a support (PDMS blocks) such that the length of the glass capillary opposite the end containing dry palmitic acid was tilted downward at a small angle)(<10°. The glass capillary and supports were heated in an oven at 80° C. During the first hour of heating, the palmitic acid was observed to melt, but the palmitic acid did not travel downward through the capillary. The heating of the capillary was continued overnight (approximately 12 hours total heating time). The palmitic acid in the open ended glass capillary showed no movement after being in the oven overnight.

### Example 2

An open-ended glass capillary (having a interior diameter of approximately 1 mm) was dipped for 20 minutes in toluene containing 1% of (2-N-benzyl-aminoethyl)-3-aminopropyl trimethoxysilane (w/v) to provide a functionalized glass capillary. The glass capillary was then removed from the toluene solution and dried in air.

The open end of the functionalized glass capillary that was placed in the toluene solution was packed with a thermally active material (approximately 5 mg of dry palmitic acid powder).

The functionalized glass capillary was placed on a support (PDMS blocks) such that the length of the functionalized glass capillary opposite the end containing dry palmitic acid was tilted downward at a small angle)(<10°. The functionalized glass capillary and supports were heated in an oven at 80° C. During the first hour of heating, the palmitic acid was observed to melt, but showed little to no movement through the functionalized glass capillary after the first hour. The heating was continued overnight. After approximately 18 hours of heating, the palmitic acid in the functionalized glass capillary moved approximately 4 cm through the capillary.

This Example demonstrates it is possible to control the rate at which a thermally active material (e.g., palmitic acid) traverses a channel.

### Prophetic Example A

A passive thermal monitoring system comprising parallel conductive surfaces having a variable distance and a thermally sensitive material there between will be fabricated as follows. A metal thin film or foil (e.g., about 1 μm to 100 μm thick) will be deposited onto or otherwise adhered to a polymer (e.g., a polyester, biaxially oriented poly(ethylene terephthalate), and the like) to provide a first electrode. A coating comprising a thermally sensitive material having a coefficient of linear thermal expansion at 20° C. of at least 10 ppm/° C. (e.g., a polyethylene, an acrylic, and the like) will then be deposited onto the metal thin film or foil using a suitable coating/printing method (e.g., spin-coating, doctor blading, and the like). The thermally sensitive material can be suspended in one or more solvents. The coating comprising the thermally sensitive material will then be cured and/or dried by heating or exposure to air. A second electrode will then be deposited (e.g., by sputtering, roll pressing, and the like) onto the thermally sensitive material to provide parallel conductive surfaces having a thermally sensitive material there between. The first and second electrodes will then be electrically connected to an integrated circuit in order to monitor the capacitance of the structure. A change in temperature will result in a change in capacitance between the parallel electrodes.

### Prophetic Example B

A passive thermal monitoring system comprising a reflective element and a thermally sensitive material will be fabricated as follows. A micro-cantilever, micro-mirror, or array thereof will be prepared using standard etching and lithography processes. A tip of a micro-cantilever or an edge of a micromirror will be embedded in a material comprising a polymer having a coefficient of linear thermal expansion at 20° C. of at least 10 ppm/° C. (e.g., a poly(dimethylsiloxane, an acrylic polymer, and the like). The polymer will have a drop shape, a thickness of 1 mm or greater, and can be deposited, e.g., by an ink jetprinting process. The material comprising the thermally sensitive material can be suspended in one or more solvents. The material comprising the thermally sensitive material will then be cured and/or dried by heating or exposure to air. A laser-diode will be aligned with the back surface of the micro-cantilever or surface of the micro-mirror, and light from the laser diode will be reflected by the back surface of the micro-cantilever or surface of the micro-mirror and detected using a photodiode or an array of photodiodes to determine the angle of reflection. A change in temperature will result in a change of the intensity of light or the angle of light reflected from the micro-cantilever or micro-mirror element(s).

### Prophetic Example C

A passive thermal monitoring system comprising two conductive surfaces separated by at least a first thermally sensitive material in a solid state will be prepared as follows. A metal foil (e.g., aluminum, and the like) will be placed on a flat surface. A thermally sensitive material having a desired melting point (e.g., tetracosane, which has a m.p. of 51° C., 2-phenylnaphthalene, which has a m.p. of 101° C., naphthyldiphenylmethane, which has a m.p. of 150° C., tetraphenylethane, which has a m.p. of 209° C., and the like) will be applied in a fluid state onto one of the metal films and then cooled. The thermally sensitive material can optionally include a dye (e.g., Keyplast Blue A, Keyplast Red 60, and the like, available from Keystone Aniline Corp., Chicago, Ill.). Suitable coating methods include doctor blading, spin-coating, and the like. A second metal foil will then be applied to the cooled thermally sensitive material to form a sandwich structure comprising two flat metal foils having a thermally sensitive material there between. Pressure will be applied to the outer surfaces of the metal foils using mechanical force applied by, e.g., affixing a clamp to the outer metal surfaces, affixing a pair of strong rare-earth magnets (e.g., NdFeB, and the like) to the outer metal surfaces, and the like. The metal foils will also be electrically connected to an integrated circuit so that the capacitance of the structure can be monitored.

Exposure of the thermally sensitive material to a temperature greater than at least one of: a phase transition temperature of the thermally sensitive material, a melting point of the thermally sensitive material, or a softening temperature of the thermally sensitive material will result in the thermally sensitive material being forced from the region between the parallel metal foils, thereby changing the capacitance between the metal foils.

### Prophetic Example D

A passive thermal monitoring system will be prepared as follows. A channel (e.g., a microfluidic channel) having a “T” or “Y” shape will be prepared by a soft lithography method (e.g., micromolding in capillaries, microtransfer molding, microcontact printing followed by etching, and the like). The inside surfaces of the channel will be coated with a mercaptosilane (e.g., (3-mercaptopropyl) trimethoxysilane). Two arms of the channel will be filled with a conductive thermally sensitive material (e.g., a solder having a desired melting point). The junction of the “T” or “Y” shaped channel will initially be void of the conductive thermally sensitive material. The ends of the two arms of the channel will be electrically connected to an integrated circuit suitable for monitoring the resistance and/or conductivity through the two arms of the channel.

The third arm of the channel will be filled with a second conductive thermally sensitive material (e.g., a low-melting point alloy solder), having a melting point lower than the first conductive thermally sensitive material.

Exposure of the passive thermal monitoring system to a temperature greater than the melting point of the second thermally active material will result in wicking (e.g., via capillary action) of the second thermally sensitive material into the void at the junction between the arms of the channel, thereby forming an electrical connection between the first two arms of the channel and changing the observed resistance and/or conductance.

### Prophetic Example E

A passive thermal monitoring system comprising first and second mechanical elements, a first magnetic material affixed on or in the first mechanical element; and a second magnetic material on or in a second mechanical element, wherein the first and second magnetic materials are attracted to one another by a magnetic force at a baseline temperature less than the Curie temperature of either magnetic material, wherein the first and second mechanical elements are configured to store potential energy in opposition to the attractive magnetic force between the first and second materials, wherein at a baseline temperature less than the Curie temperature of either magnetic material the stored potential energy is less than the magnetic attractive force between the first and second magnetic materials, and wherein at a temperature above the baseline temperature the attractive force between the first and second magnetic materials decreases such that the attractive force is less than the potential energy, and the potential energy is released as a mechanical reconfiguration of at least one of the first or second mechanical elements will be prepared as follows.

A plurality of microposts comprising an elastomer (e.g., PDMS) will be formed by a contact patterning method (e.g., microtransfer molding, micromolding in capillaries, and the like). The microposts will have a height of 50 μm to 150 μm, an aspect ratio (height:lateral dimension) of 1:1 to 3:1, and a spacing between microposts of 35 μm to 150 μm such that the microposts will be able to bend at least 30 degrees from an upright position. The tips of the microposts will contain a plurality of magnetic micro- and/or nano-particles having a Curie temperature (e.g., iron oxide particles). The substrate surrounding the microposts can be optionally colored (e.g., red, green, yellow, and the like). The system will be heated above the Curie temperature of the micro- and/or nano-particles and then poled parallel to the length of the microposts during cooling. A strong rare earth magnet (e.g., NdFeB and the like) will be placed at one end of the micropost array, and the magnetic field normal to the axis of the microposts will cause the microposts to physically bend toward (or away from) the magnet.

Exposure of the passive thermal monitoring system to a temperature above the Curie temperature of the magnetic particles will cause the microposts to straighten to a vertical orientation due to the stored potential energy in the elastomer, thereby revealing a color of the substrate surrounding the microposts and causing a change in the optical appearance of the passive thermal monitoring system.

### Prophetic Example F

A passive thermal monitoring system comprising a reflective element and a magnetic material will be fabricated as follows. A micro-cantilever, micro-mirror, or array thereof will be prepared using standard etching and lithography processes. A magnetic material will be applied to a tip of a micro-cantilever or an edge of a micromirror. A strong rare earth magnet (e.g., NdFeB, and the like) will be placed on a surface adjacent to the tip of the micro-cantilever or micro-mirror edge in a physical arrangement such that magnetic material and the strong rare earth magnet are attracted to each other. A laser-diode will be aligned with the back surface of the micro-cantilever or surface of the micro-mirror, and light from the laser diode will be reflected by the back surface of the micro-cantilever or surface of the micro-mirror and detected using a photodiode or an array of photodiodes to determine the angle of reflection. Exposure of the passive thermal monitoring system to a temperature above the Curie temperature of the magnetic material will result in a change of the intensity of light or the angle of light reflected from the micro-cantilever or micro-mirror element(s) due to relaxation of the cantilever or micromirror to an equilibrium position.

In a modified design, the passive thermal monitoring system will comprise a plurality of micro-springs affixed to a surface, wherein the micro-springs include a magnetic material affixed to one end of each of the micro-springs and a strong rare earth magnet affixed to the other ends of the micro-springs.

### Prophetic Example G

A passive thermal monitoring system comprising a magnetic material having a Curie temperature will be prepared as follows. A conductive coil (e.g., a coiled wire, a microfluidic channel, and the like) will be placed around at least a portion of a capillary (e.g., a microfluidic channel, a glass and/or plastic capillary tube, and the like). The inner diameter of the capillary will be 50 μm to 1 mm. A magnetic material having a Curie temperature (e.g., a plurality of particles, a monolithic material and/or a ferrofluid) will be placed in the capillary. The coil will be connected to an integrated circuit and an alternating current will be applied to the coil to monitor the inductance. Exposure of the passive thermal monitoring system to increasing temperatures will result in a decrease in inductance, the magnitude of which will mark the maximum temperature to which the passive thermal monitoring system will be exposed.

### CONCLUSION

These Examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A passive thermal monitoring system comprising:
a matrix including at least a first channel therein, wherein the first channel has a cross-sectional area; and
at least a first thermally active material having a melting point within:
a first range of −20° C. to 50° C., or
a second range of 51° C. to 100° C., or
a third range of 101° C. to 150° C., or
a fourth range of 151° C. to 200° C., or
a fifth range of 201° C. to 250° C.;
wherein the first thermally active material is positioned to be in fluid communication with at least the first channel in a fluid state, and wherein a flow of the first thermally active material in a fluid state into and through at least the first channel occurs only above a threshold temperature characteristic of an interaction between the first thermally active material and the first channel.

2. The passive thermal monitoring system of claim 1, wherein the first channel comprises a first functional group.

3. The passive thermal monitoring system of claim 2, wherein the first thermally active material is a substantially pure, optionally substituted hydrophobic alkane, and the first functional group is a hydrophobic functional group.

4. The passive thermal monitoring system of claim 1, comprising a second thermally active material having a melting point within one of the first range through fifth ranges, wherein the melting points of the first and the second thermally active materials are in different ranges, wherein the second thermally active material is positioned to be in fluid communication with at least a second channel in a fluid state, and wherein a flow of the second thermally active material in a fluid state into and through at least the second channel occurs only above a threshold temperature characteristic of an interaction between the second thermally active material and the second channel.

5. The passive thermal monitoring system of claim 4, wherein the second channel comprises a second functional group.

6. The passive thermal monitoring system of claim 5, wherein the second thermally active material is a substantially pure, optionally substituted hydrophilic alkane, and the second functional group is a hydrophobic functional group.

7. The passive thermal monitoring system of claim 4, wherein the first and second channels are in at least partial fluid communication.

8. The passive thermal monitoring system of claim 4, comprising a third thermally active material having a melting point within one of the first through fifth ranges, wherein the melting points of the first, second, and third thermally active materials are in different ranges, wherein the third thermally active material is positioned to be in fluid communication with at least a third channel in a fluid state, and wherein a flow of the third thermally active material in a fluid state into and through at least the third channel occurs only above a threshold temperature characteristic of an interaction between the third thermally active material and the third channel.

9. The passive thermal monitoring system of claim 8, wherein the third channel comprises a third functional group.

10. The passive thermal monitoring system of claim 9, wherein the third thermally active material is a eutectic metal and the third functional group is a hydrophilic functional group.

11. The passive thermal monitoring system of claim 8, wherein the first, second and third channels are in at least partial fluid communication.

12. The passive thermal monitoring system of claim 8, comprising: a fourth thermally active material having a melting point within one of the first through fifth ranges, wherein the melting points of the first, second, third, and fourth thermally active materials are in different ranges, wherein the fourth thermally active material is positioned to be in fluid communication with at least a fourth channel in a fluid state, and wherein a flow of the fourth thermally active material in a fluid state into and through at least the fourth channel occurs only above a threshold temperature characteristic of an interaction between the fourth thermally active material and the fourth channel.

13. The passive thermal monitoring system of claim 12, wherein the fourth channel comprises a fourth functional group.

14. The passive thermal monitoring system of claim 13, wherein the fourth thermally active material is a eutectic metal, and the fourth functional group is a hydrophilic functional group.

15. The passive thermal monitoring system of claim 12, wherein the first, second, third and fourth channels are in at least partial fluid communication.

16. A passive thermal monitoring system comprising:
a matrix that includes a plurality of channels therein, wherein each channel has an independent cross-sectional area of 10 mm² or less; and
a thermally active material that is positioned to be in fluid communication with the plurality of channels in a fluid state;
wherein a flow of the thermally active material in a fluid state into one or more of the channels is temperature dependent and occurs above a threshold temperature characteristic of an individual channel,
wherein the thermally active material in a fluid state progresses through one or more of the channels above the threshold temperature characteristic of an individual channel, and
wherein the threshold temperature at which the thermally active material flows into and then progresses through each of the individual channels is different.

17. The passive thermal monitoring system of claim 16, wherein the thermally active material in one or more of the plurality of channels is stationary below the threshold temperature characteristic of each of the channels.

18. The passive thermal monitoring system of claim 16, wherein the thermally active material has a melting point of −20° C. to 250° C.

19. The passive thermal monitoring system of claim 16, wherein the thermally active material is selected from a liquid, a solid, a semi-solid, a colloid, a gel, a wax, a fat, an oil, a metal, an ionic liquid, an oligomer, a polymer, a co-polymer, and combinations thereof.

20. The passive thermal monitoring system of claim 16, wherein one or more of the channels is in fluid communication with a reservoir at a first end of the channel and is in partial fluid communication with a reservoir at a second end of the channel.

21. The passive thermal monitoring system of claim 16, wherein one or more of the channels is fluidly isolated from the other channels.

22. The passive thermal monitoring system of claim 16, wherein at least one of the plurality of channels comprises a functional group.

23. The passive thermal monitoring system of claim 22, wherein the flow into and the rate of flow of the thermally active material through one or more of the plurality of channels is dependent on at least a functional group within or on at least a portion of the channel.

24. The passive thermal monitoring system of claim 22, wherein the functional group interacts with a component of the thermally active material to induce at least one of: a color change, a change in refractive index, a change in reflectance, or a combination thereof within at least one of the plurality of channels.

25. The passive thermal monitoring system of claim 16, wherein the flow into and the rate of flow of the thermally active material through one or more of the channels is dependent on at least the independent cross-sectional area of the channel.

26. The passive thermal monitoring system of claim 16, wherein the monitoring system is suitable for recording the temperature history of an object from 30° C. to 250° C.

27. A passive thermal monitoring system comprising:
a flexible matrix including at least a first, a second, a third and a fourth channel therein, wherein the first, second, third and fourth channels have a cross-sectional area that is the same or different;
a first thermally active material having a melting point of −20° C. to 60° C., wherein the first thermally active material is positioned to be in fluid communication with at least the first channel in a fluid state, and wherein a rate of flow of the first thermally active material in a fluid state into and through at least the first channel occurs only above a threshold temperature that is −20° C. to 60° C.;
a second thermally active material having a melting point of 61° C. to 120° C., wherein the second thermally active material is positioned to be in fluid communication with at least the second channel in a fluid state, and wherein a rate of flow of the second thermally active material in a fluid state into and through at least the second channel occurs only above a threshold temperature that is 61° C. to 120° C.;
a third thermally active material having a melting point of 121° C. to 180° C., wherein the third thermally active material is positioned to be in fluid communication with at least the third channel in a fluid state, and wherein a rate of flow of the third thermally active material in a fluid state into and through at least the third channel occurs only above a threshold temperature that is 121° C. to 180° C.; and
a fourth thermally active material having a melting point of 181° C. to 250° C., wherein the fourth thermally active material is positioned to be in fluid communication with at least the fourth channel in a fluid state, and wherein a rate of flow of the fourth thermally active material in a fluid state into and through at least the fourth channel occurs only above a threshold temperature that is 181° C. to 250° C.

28. The passive thermal monitoring system of claim 27, wherein the first channel comprises a first functional group, the second channel comprises a second functional group, the third channel comprises a third functional group, and the fourth channel comprises a fourth functional group; and wherein the first, second, third and fourth functional groups are independently the same or different.

29. The passive thermal monitoring system of claim 28, wherein the rate of flow of the first thermally active material in a fluid state into and through at least the first channel is dependent on at least an interaction between the first thermally active material and the first functional group; wherein the rate of flow of the second thermally active material in a fluid state into and through at least the second channel is dependent on at least an interaction between the second thermally active material and the second functional group; wherein the rate of flow of the third thermally active material in a fluid state into and through at least the third channel is dependent on at least an interaction between the third thermally active material and the third functional group; wherein the rate of flow of the fourth thermally active material in a fluid state into and through at least the fourth channel is dependent on at least an interaction between the fourth thermally active material and the fourth functional group.

30. A passive thermal monitoring system comprising:
a matrix that includes a channel therein having an opening and a terminus, wherein the channel comprises a plurality of fluidly connected segments, each segment having a cross-sectional area of 10 mm² or less; and
a thermally active material having a melting point of −20° C. to 250° C., wherein the thermally active material is positioned to be in fluid communication with the beginning of the channel in a fluid state,
wherein a flow of the thermally active material in a fluid state into the channel is temperature dependent and occurs only above a threshold temperature characteristic of an interaction between the thermally active material and the beginning of the channel,
wherein a rate of flow of the thermally active material in a fluid state into each segment of the channel is temperature dependent above a threshold temperature characteristic of each segment of the channel and occurs only above a threshold temperature characteristic each segment of the channel,
wherein a rate of flow of the thermally active material in a fluid state through one or more segments of the channel is temperature independent above the threshold temperature characteristic of the segment of the channel, and
wherein the characteristic temperature of each segment of the channel is different and increases as the distance of each segment from the opening of the channel increases.

31. The passive thermal monitoring system of claim 30, wherein the position of the thermally active material in one or more segments of the channel is stationary below a threshold temperature characteristic of the segment of the channel.

32. The passive thermal monitoring system of claim 30, wherein the thermally active material is selected from: water, a wax, a fat, an oil, an ionic liquid, a copolymer, a polymer, a solder, and combinations thereof.

33. The passive thermal monitoring system of any of claims 1, 16, 27 or 30, wherein a colorant is mixed with the thermally active material.

34. The passive thermal monitoring system of claim 30, wherein at least a portion of a surface of at least one of the one or more segments comprises one or more functional groups thereon that are the same or different between the plurality of segments.

35. The passive thermal monitoring system of claim 34, wherein the characteristic temperature of one or more of the segment of the channel depends at least on an interaction between the thermally active material and one or more functional groups within or on one or more segments of the channel.

36. The passive thermal monitoring system of claim 30, wherein the characteristic temperature of one or more segments of the channel depends at least on the independent cross-sectional area of the segments of the channel.

37. The passive thermal monitoring system of claim 30, wherein one or more of the segments comprises a plurality of capillary channels extending from a surface of the segment, wherein a rate of flow of the thermally active material into and through each capillary channel of a segment of the channel is different and depends on at least one of: an ambient temperature, a functional group present on at least a portion of a surface of the capillary channel, and a cross-sectional area of the capillary channel.

38. The passive thermal monitoring system of any of claims 1, 16, 27 or 30, wherein the matrix is transparent or opaque to visible light.

39. The passive thermal monitoring system of any of claims 1, 16, 27 or 30, wherein the matrix is flexible.

40. The passive thermal monitoring system of any of claims 1, 16, 27 or 30, wherein the matrix comprises a self adhesive backing layer.

41. A passive thermal monitoring system comprising a magnetic material having a Curie temperature, the magnetic material having a known magnetic moment at a baseline temperature that is less than the Curie temperature, wherein exposure of the passive thermal monitoring system to a temperature greater than the baseline temperature provides an incremental decrease in the magnetic moment of the magnetic material such that the decrease in the magnetic moment after a period of use correlates with a maximum temperature to which the passive thermal monitoring system is exposed during the period of use.

42. The passive thermal monitoring system of claim 41, wherein the magnetic material has a Curie temperature of −100° C. to 1200° C.

43. A passive thermal monitoring system comprising:
first and second mechanical elements,
a first magnetic material affixed on or in the first mechanical element; and
a second magnetic material on or in a second mechanical element,
wherein the first and second magnetic materials are attracted to one another by a magnetic force at a baseline temperature less than the Curie temperature of either magnetic material,
wherein the first and second mechanical elements are configured to store potential energy in opposition to the attractive magnetic force between the first and second materials,
wherein at a baseline temperature less than the Curie temperature of either magnetic material the stored potential energy is less than the magnetic attractive force between the first and second magnetic materials, and
wherein at a temperature above the baseline temperature the attractive force between the first and second magnetic materials decreases such that the attractive force is less than the potential energy, and the potential energy is released as a mechanical reconfiguration of at least one of the first or second mechanical elements.

44. The thermal monitoring system of claim 43, wherein the first and second mechanical elements are selected from: a substrate, a cantilever, a micromirror, a hinge, a deflector, a microfluidic valve, and combinations thereof.

45. A passive thermal monitoring system comprising parallel conductive surfaces having a variable distance and a thermally sensitive material there between, wherein the thermally sensitive material has a coefficient of linear thermal expansion at 20° C. of at least 10 ppm/° C., and wherein change of the thermally sensitive material results in a change in capacitance between the parallel conductive surfaces.

46. A passive thermal monitoring system comprising a reflective element and a thermally sensitive material having a coefficient of linear thermal expansion at 20° C. of at least 10 ppm/° C., wherein change of the thermally sensitive material modifies at least one of: the intensity of light or the angle of light reflected from the reflective element.

47. The passive thermal monitoring system of claim 46, comprising a light source, wherein the reflective element is a mirror, and linear expansion of the material modifies at least the angle of light reflected from the reflective element.

48. The passive thermal monitoring system of any of claim 45 or 46, wherein the thermally sensitive material is an elastomer.

49. A passive thermal monitoring system comprising at least a first thermally sensitive material in a solid state, wherein exposure of at least the first thermally sensitive material to a temperature greater than at least one of: a phase transition temperature of the first thermally sensitive material, a melting point of the first thermally sensitive material, or a softening temperature of the first thermally sensitive material provides an observable change in the passive thermal monitoring system.

50. The passive thermal monitoring system of claim 49, comprising two conductive surfaces separated by at least the first thermally sensitive material in a solid state, wherein exposure of the first thermally sensitive material to a temperature greater than at least one of: a phase transition temperature of the first thermally sensitive material, a melting point of the first thermally sensitive material, or a softening temperature of the first thermally sensitive material provides a change in the conductivity between the two conductive surfaces.

51. The passive thermal monitoring system of claim 49, comprising a second thermally sensitive material in a solid state, wherein exposure of the first and second thermally sensitive materials to a temperature greater than the melting points of the first and second thermally sensitive materials provides a mixing of the first and second thermally sensitive materials.

52. The passive thermal monitoring system of claim 49, wherein at least one of the first and second thermally sensitive materials comprises a colorant, wherein mixing of the first and second thermally sensitive materials results in a color change, and wherein the color change correlates with a maximum temperature to which the passive thermal monitoring is exposed.

53. The passive thermal monitoring system of claim 49, wherein exposure of at least the first thermally sensitive material to a temperature greater than at least one of: a phase transition temperature of the first thermally sensitive material, a melting point of the first thermally sensitive material, or a softening temperature of the first thermally sensitive material provides a relaxation of the of the passive thermal monitoring system into a relaxed state that is observable by a process selected from: a change in physical shape, a color change, an electrical capacitance change, an electrical conductivity change, a signal frequency change, and combinations thereof.
